(19) United States
(12) Patent Application Publication
(10) Pub. No.: US 2022/0260379 A1
(43) Pub. Date: Aug. 18, 2022

(54) Methods and Apparatus for Determining a Likelihood of Successful Transmission of Data from a Mobile Vehicle

(71) Applicant: Atlis Motor Vehicles, Inc., Mesa, AZ (US)

(72) Inventor: Mark Hanchett, Mesa, AZ (US)

(73) Assignee: Atlis Motor Vehicles, Inc., Mesa, AZ (US)

(21) Appl. No.: 17/737,237

(22) Filed: May 5, 2022

Related U.S. Application Data
(60) Provisional application No. 63/185,614, filed on May 7, 2021.

(51) Int. Cl. G01C 21/34

(52) U.S. Cl. CPC G01C 21/3461; G01C 21/3492

(57) ABSTRACT

A mobile vehicle may physically transport and subsequently wirelessly transmit data to remote equipment. Prior to transmitting the data, the mobile vehicle may identify road in range segments (“RIRSs”) to determine the likelihood that the transmission will be successful. RIRSs are the portions of the road traveled by the mobile vehicle in the proximity of the remote equipment where the mobile vehicle and the remote equipment can wirelessly communicate with each other. An RIRS is established where the transmission range of mobile vehicle overlaps the remote equipment and the transmission range of the remote equipment overlaps the road where the mobile vehicle travels. The distance of the RIRS may be used to determine a likelihood that the transmission will be successful. The mobile vehicle wirelessly transmits the data if the transmission will likely be successful. A probability factor may be applied to determine the likelihood of successful transmission.

### FIELD OF THE INVENTION

Embodiments of the present disclosure relate to electric vehicles, charging stations and other electric vehicle-like equipment.

### BACKGROUND

As electric vehicles and other electric machines become more prevalent, there will need to be more charging stations to support the electric vehicles and machines. Some charging stations, just as gas stations today, will need to be in remote locations. Further, some electric vehicles and machines that use the remote charging stations will remain in remote locations for extended periods for time. Many remote locations will not have access to a communication network and in particular to a long-range communication network (e.g., long-range network). Lacking a communication network, receiving data from and/or sending data to the charging stations, vehicles and machines positioned at a remote location may be difficult if not impossible. Owners of charging stations, vehicles and machines in remote locations may benefit from mobile vehicles that transfer data to and from charging stations, electric vehicles and/or electric machines positioned in remote locations.

The transfer of data by a mobile vehicle to or from a charging station, an electric vehicle and/or an electric machine positioned in remote area may fail due to circumstances in the remote area. The successful transfer data may be improved by determining the likelihood of successful transfer prior to attempting transfer.

### BRIEF DESCRIPTION OF THE DRAWING

Embodiments of the present invention will be described with reference to the drawing, wherein like designations denote like elements, and:

FIG. 1 is a diagram of an electric vehicle driving along a road past a remote equipment;

FIGS. 2-7 are diagrams of an example embodiment of road in range segments (“RIRSs”) created by a remote equipment along a road traveled by a mobile vehicle;

FIGS. 8-9 are diagrams illustrating the effect of example embodiments of geographic position of the remote equipment on the RIRSs;

FIG. 10 is a block diagram of an example embodiment of a computer for remote equipment;

FIG. 11 is a block diagram of an example embodiment of a computer for a mobile vehicle;

FIG. 12 is a diagram of an example embodiment of a data structure for remote equipment data;

FIG. 13 is a diagram of an example embodiment of a method for determining the RIRSs;

FIG. 14 is a diagram of an example embodiment of a data structure for probability data;

FIG. 15 is a diagram of an implementation of an example embodiment of the data structure for public ability data;

FIG. 16 is a diagram of an example embodiment of a method for a mobile vehicle to transmit data to remote equipment according to various aspects of the present disclosure;

FIG. 17 is a diagram of an example embodiment of a method for a mobile vehicle to receive data from remote equipment according to various aspects of the present disclosure; and

FIGS. 18-19 are diagrams illustrating the effect of different transmission ranges on the RIRSs.

### DETAILED DESCRIPTION

### 1. Overview

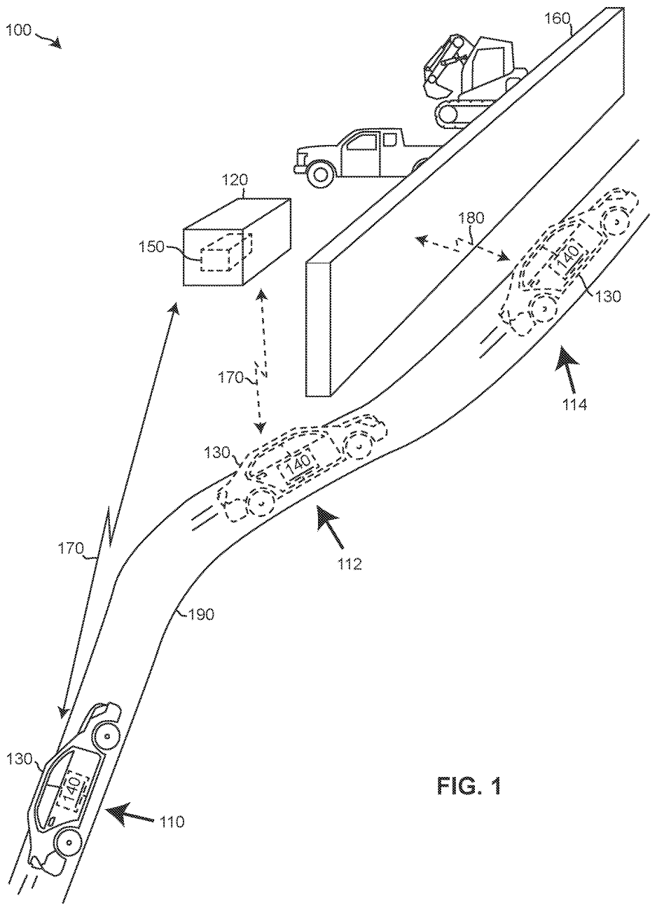

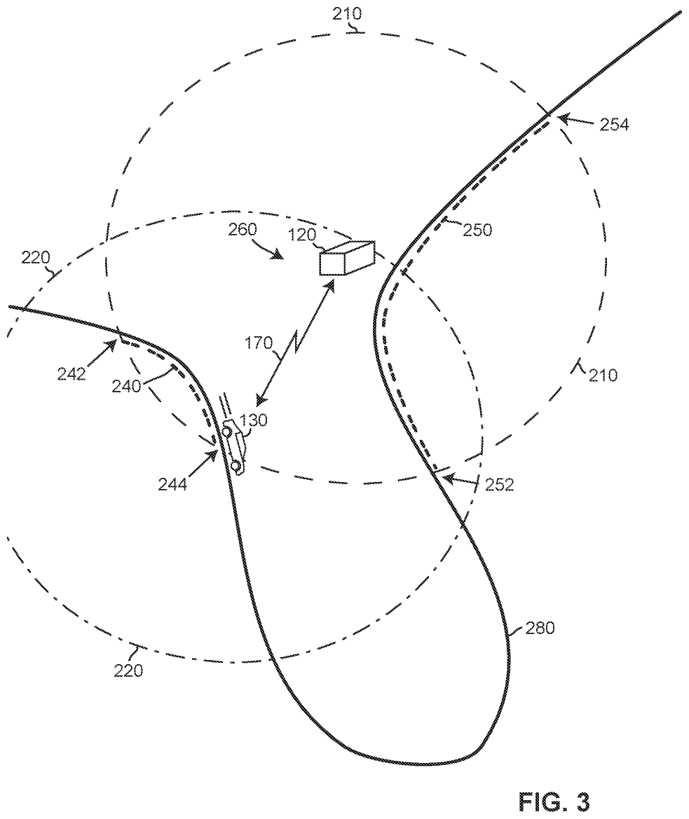

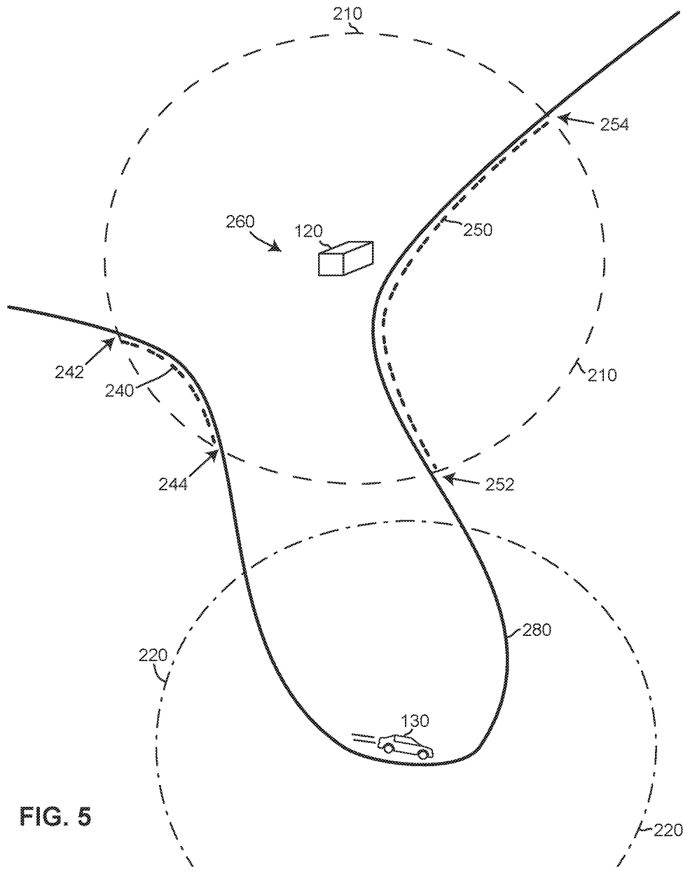

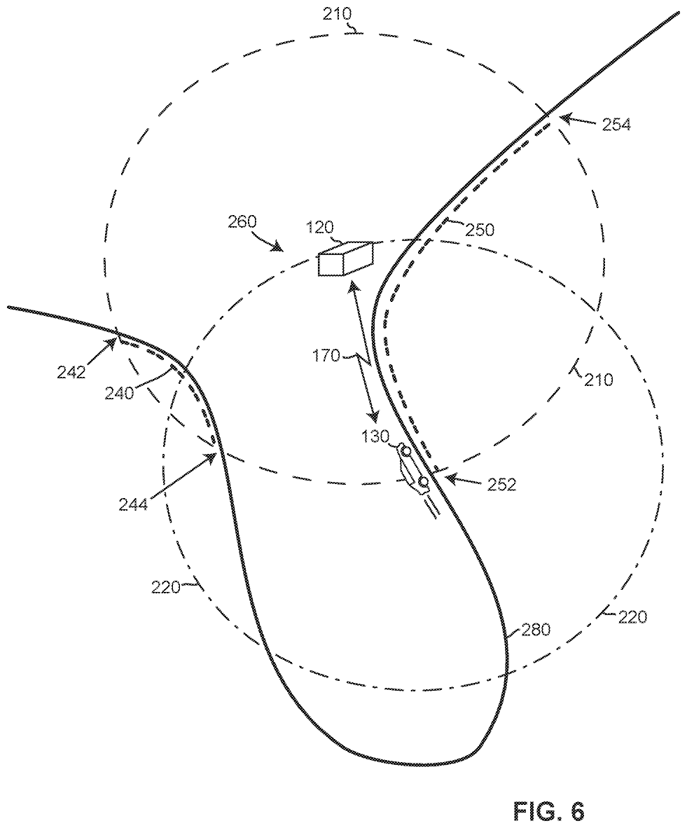

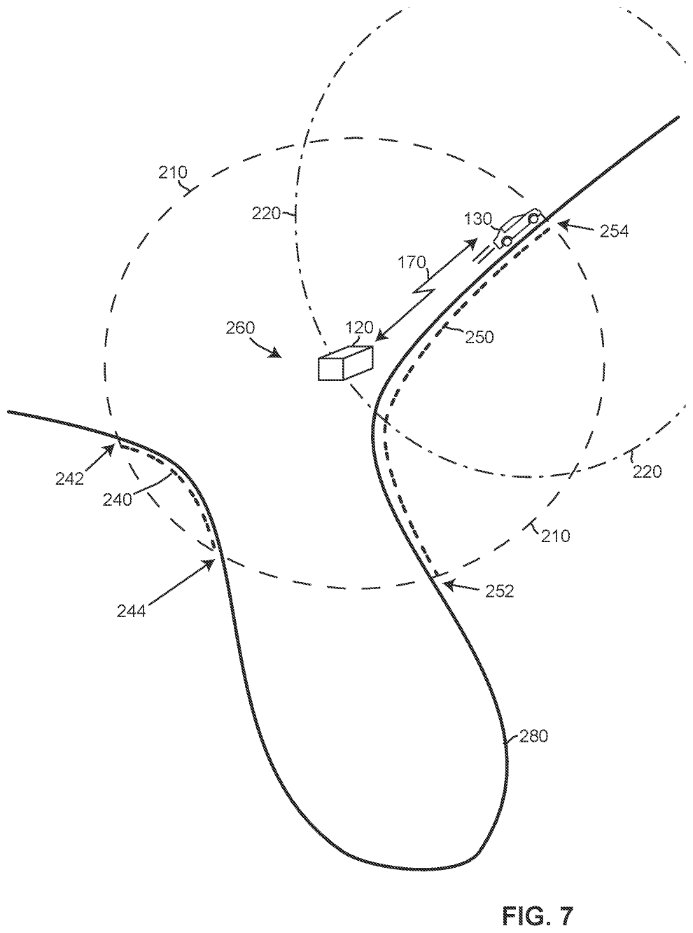

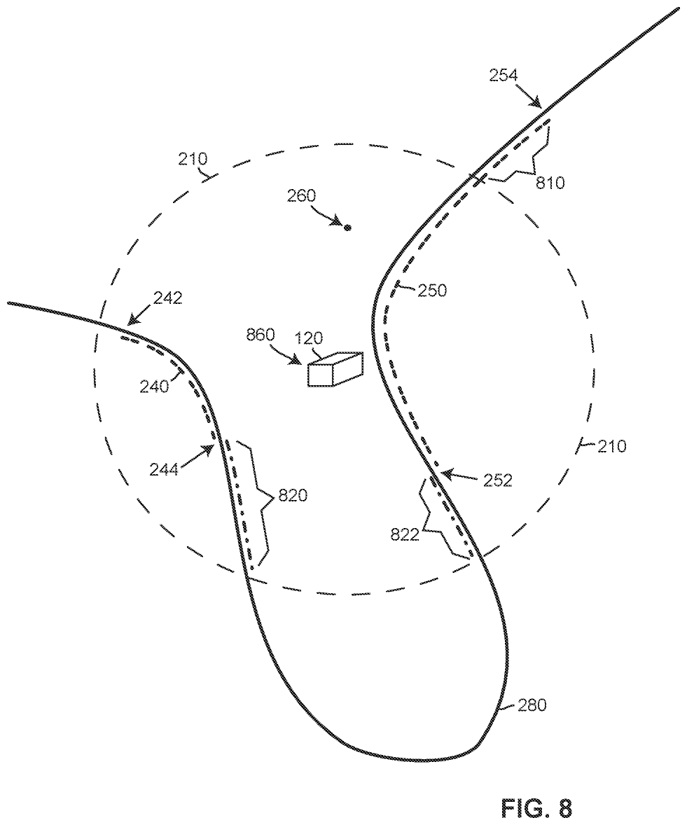

Electric vehicles, charging stations and/or electric machines (e.g., tractors, agricultural equipment, construction equipment, excavation equipment, similar equipment) tend to include advanced technology and, generally, are “connected” devices. The term “connected” means that the electric vehicles, charging stations and electric machines are able to communicate (e.g., transmit, receive) with each other and/or with other electronic devices. An electric vehicle, charging station or electric machine that has access to a long-range network is able to communicate with a server that is physically distant from the vehicle, the charging station or the electric machine. However, electric vehicles, charging stations and/or electric machines that are positioned at a remote location (e.g., area) with no connection to the long-range network cannot communicate with the server. Electric vehicles, charging stations and/or electric machines that are positioned in a remote location on a relatively long-term basis that cannot communicate with the server are referred to herein as remote equipment. A remote equipment 120 in FIGS. 1-9 and 16-19 represents an electric vehicle, a charging station or an electric machine positioned in a remote location.

Electric vehicles, or even conventional vehicles, may be used to physically transport (e.g., ferry, carry, haul, transfer) then subsequently electronically transmit data between (e.g., to, from) the server and the remote equipment 120 thereby enabling communicate between the server and the remote equipment 120. Electric or conventional vehicles may travel to a location (e.g., city) that provides access to the server. While at the location, the electric or conventional vehicle may receive data from the server intended for transfer to remote equipment. The electric or conventional vehicle may subsequently drive from the city to the remote location where the remote equipment is located thereby physically transporting the data to the remote location. While in the remote location, the electric or conventional vehicle may wirelessly transmit the data to remote equipment thereby completing the transfer from the server to the remote equipment.

While in the remote location, the electric or conventional vehicle may receive data intended for the server from the remote equipment by wireless transmission. The electric or conventional vehicle may subsequently drive to the location that provides access to the server thereby physically transporting the data to the location. While in the location, the electric or conventional vehicle may wirelessly transmit the data to the server via a long-range network to complete the transfer from the remote equipment to the server. Vehicles, whether electric or conventional, that are used to transfer information between a server, or some other source, and remote equipment is referred to herein as a mobile vehicle.

More information regarding the transfer of data between a server and remote equipment may be found in U.S. patent application Ser. No. 17/722,548 filed Apr. 18, 2022 with the title “Methods and Apparatus for Transport and Transmission of Data to and from a Remote Location”, which is here by incorporated by reference.

The disclosure of the present application is directed toward the wireless communication between the mobile vehicle and the remote equipment in the remote location. As a mobile vehicle 130 moves along a road (e.g., travels, drives), it may wirelessly communicate with the remote equipment 120 to transmit data to or receive data from the remote equipment 120. However, circumstances (e.g., conditions) at the remote location 100 may decrease the likelihood that the mobile vehicle 130 may transmit data to or receive data from the remote equipment 120. Some circumstances are detectable while other circumstances occur randomly.

For example, referring to FIG. 1, at position 110 on road 190, the mobile vehicle 130 is able to establish wireless link 170 with the remote equipment 120 to communicate with the remote equipment 120. As the mobile vehicle 130 continues to travel along the road 190, the mobile vehicle 130 is still able to communicate with the remote equipment 120 at position 112. However, when the mobile vehicle 130 reaches a position 114, a barrier 160 blocks the wireless signal 180 from the mobile vehicle 130 so it does not reach the remote equipment 120 thereby interrupting communication. The disclosure of the present application discusses methods and apparatus for determining a likelihood that the mobile vehicle 130 will be able to successfully communicate with the remote equipment 120 as it travels along the road 190.

Factors that enable determining whether communication with the remote equipment 120 is likely to be successful include, inter alia, determining the amount of time that is available for communication, identifying barriers (e.g., objects) that may interfere with communication, and accounting for other occurrences such as, inter alia, traffic density, competition for bandwidth, solar activity, speed of the mobile vehicle 130 and weather.

### 2. Communication Between Mobile Vehicle and Remote Equipment

In the present application, communication is frequently described as communication between the mobile vehicle 130 and the remote equipment 120. In actuality the communication occurs between a vehicle computer 140, which is attached to the mobile vehicle 130, and the remote equipment computer 150, which is attached to or positioned near the remote equipment 120. Communication between the mobile vehicle 130 and the remote equipment 120 is accomplished via short-range wireless broadcasts or short-range wireless links (e.g., communication links, 170) between the vehicle computer 140 using a short-range communication circuit 1150 and the remote equipment computer 150 using a short-range communication circuit 1050.

For clarity, broadcast means the transmission from one device (e.g., mobile vehicle, charging station, electric machine) to many devices. One or more devices may respond to a broadcast. A broadcast is a transmission that does not receive an acknowledgment of receipt. Data that is broadcast may be received by any device that is in wireless range of the transmitter. A link is established for one-to-one communication in which one device communicates with another device. A device may establish a plurality of links that operate at the same time; however, each link communicates with a single device. Any acceptable communication protocol may be used for wireless broadcasts and/or to establish and use wireless links.

The vehicle computer 140 and the remote equipment computer 150 may include the authentication data 1122 and the authentication data 1022 respectively. The authentication data 1122 and the authentication data 1022 enable the vehicle computer 140 and the remote equipment computer 150 to authenticate each other and/or to communicate securely. Data may be broadcast without authentication. Communication may occur with or without authentication. The vehicle computer 140 and the remote equipment computer 150 are discussed in greater detail below.

### 3. Overview of Determining the Likelihood of Successful Transmission

As discussed above, mobile vehicles will benefit from being able to determine whether transmission of data to remote equipment or reception of data from remote equipment will be successful prior to starting transmission or reception. The vehicle computer 140 may perform various operations to determine the likelihood of whether the transmission (e.g., transmission to remote equipment, transmission from remote equipment) will be successful. These operations are described below. Some of the operations are described in greater detail in separate sections. These operations assume that the vehicle travels along and remains on a road that is described in the map data 1128 of the vehicle computer 140. The speed of the vehicle is controlled by the driver independent of any attempt made by the vehicle computer 140 to transmit or receive data; however, it is possible for the vehicle computer 140 to request that the driver slow the speed of the mobile vehicle 130 to increase the likelihood of successful communication, but the driver is not required to comply.

3.1 Operation: Identify Road in Range Segments (RIRSs)

A portion of a road (e.g., segment) that is overlapped by the area of coverage of the short-range communication circuit 1050 of the remote equipment 120 is a segment of the road that is in the transmission range of the remote equipment 120. Such a segment is referred to as a road in range segment (“RIRS”). While the mobile vehicle 130 is driving through an RIRS, it can transmit data to and/or receive data from the remote equipment 120. While the mobile vehicle 130 is not in an RIRS, it cannot communicate with the remote equipment 120. Since the mobile vehicle 130 can only communicate with the remote equipment 120 while it is positioned in an RIRS, knowing the geographic locations of the road in range segments (“RIRSs”) of the remote equipment 120 is useful for calculating the likelihood of successful transmission and/or reception.

3.2 Operation: Determine the Present Geographic Location of the Mobile Vehicle

Detecting the present geographic location of the mobile vehicle 130 aids in determining the road being traveled by the mobile vehicle 130, proximity to the remote equipment 120 and whether the mobile vehicle 130 is positioned in in an RIRS. Determining the present geographic location of the mobile vehicle 130 may be accomplished using a GPS receiver. The datum used by the GPS receiver should be the same as the datum of the data stored in the map data 1128.

3.3 Operation: Determine Whether the Mobile Vehicle is in an RIRS

Determining whether the mobile vehicle 130 is positioned in an RIRS may be accomplished by detecting a coincidence (e.g., overlap) between the present geographic location of the mobile vehicle 130 and an RIRS. Because the mobile vehicle 130 drives through an RIRS, the mobile vehicle 130 may also determine its position relative to the beginning and the end of the MRS.

3.4 Operation: Determine Remaining Time in an RIRS

While the mobile vehicle 130 is driving (e.g., moving) along the road, as soon as it enters an RIRS, it can start transmitting or receiving data; however, as soon exits the RIRS, communication stops. Since the length of an MRS is finite, the amount of time that the mobile vehicle 130 will be positioned in an RIRS will also be finite. The amount of time available for transmission and/or reception also depends on the speed of the vehicle. As discussed above, knowing the amount of time available for transmission and/or reception aids in determining whether transmission and/or reception will be successful.

3.5 Operation: Determining the Speed of the Mobile Vehicle

As discussed above, the speed of the mobile vehicle 130 is a factor in determining the amount of time the mobile vehicle 130 will be positioned in an RIRS and therefore the amount of time available for transmission and/or reception. The speed of the mobile vehicle 130 may be determined in any way. In one embodiment, the GPS receiver determines the speed of the mobile vehicle 130. In another embodiment, the speed of the mobile vehicle 130 is determined using a speedometer. In another embodiment, the speed of the mobile vehicle 130 is determined using sensors that are attached to the mobile vehicle 130. The speed may be monitored at intervals (e.g., continuously, nearly continuously, discreetly) to determine whether changes in the speed of the mobile vehicle 130 increase or decrease the likelihood that the data may be transmitted and/or received successfully.

3.6 Operation: Applying a Probability Factor

Many different occurrences or circumstances may affect whether the transmission and/or reception between the mobile vehicle 130 and the remote equipment 120 is successful. Some phenomenon that may interfere with radiocommunication may occur regularly, but have an unforeseeable aspect. For example, solar radiation (e.g., sunspots) affects radiocommunication. Solar radiation increases and decreases over an 11-year cycle, but the magnitude of the solar radiation at any place in the cycle may be different than the previous cycle. So, even though an increase in solar radiation may be predicted, its magnitude and its effects on transmission or reception is probabilistic in nature. Traffic along a road may wax and wane over a year and during different times of the day, but the exact amounts of traffic for any given time frame may fluctuate. So, even though an increase in traffic, and therefore competition for bandwidth and transmission interference may be predicted, the amount of competition or interference is also probabilistic in nature. In another example, the radio signal may be absorbed or reflected by an object (e.g., geographic object, mountain, hill, rock, wall) but the amount of absorption or reflection may depend on the speed of the vehicle, the atmospheric temperature, atmospheric conditions (e.g., clouds, lightning), a change in the surface of the object (e.g., rain, snow, dust, ice) or other factors. So, even though the speed of the vehicle, atmospheric conditions, the weather can improve or deteriorate transmission, the amount of improvement or deterioration is also probabilistic in nature.

The probability factor may account for known factors that affect transmission or reception, but whose magnitude of their effect can change thereby increasing or decreasing, likely decreasing, the likelihood of successful transmission or reception. The probability factor may be applied to some aspect of transmission or reception to identify an increase or a decrease in the likelihood of successful transmission or reception. For example, the probability factor may be applied to the amount of time available for transmission or reception to determine an adjusted amount of time available, which may affect whether transmission or reception will be successful.

3.7 Operation: Determining Whether to Transmit or Receive

Once the mobile vehicle 130 has determined that it is positioned in an RIRS, it can determine the amount of time available for transmission and/or reception. The available time represents an upper limit on the amount of time available for transmission and/or reception. The probability factor may be applied to the amount of time available to determine an adjusted amount of time available for transmission and/or reception. In most circumstances, applying the probability factor to the amount of time available results in an adjusted amount of time available that is less than the calculated amount of time available because probabilistic factors generally operate to deteriorate transmission and/or reception.

Using the amount of time available or the adjusted amount of time available, the mobile vehicle 130 may determine whether the data can be transmitted or received in the amount of time available. If the mobile vehicle 130 can transmit or receive all of the data, including overhead (e.g., link setup, data analysis, possible retransmission), in the amount of time available, then it is highly likely that the transmission or reception will be successful and the mobile vehicle 130 should start transmission and/or reception. If the amount of data that needs to be transmitted or received cannot be transmitted or received in the amount of time available, then it is highly likely, if not a surety, that the transmission or reception will fail. Applying the probability factor can increase the likelihood of successful transmission or reception, or the likelihood of an unsuccessful transmission or reception because it accounts for probabilistic factors that can affect transmission and/or reception. The likely amount of retransmitted data or protocol overhead may be included in the probability factor.

Several of the above operations may be discussed below in greater detail or presented as an operation performed in an example embodiment of a method.

### 4. Road in Range Segment (RIRS)

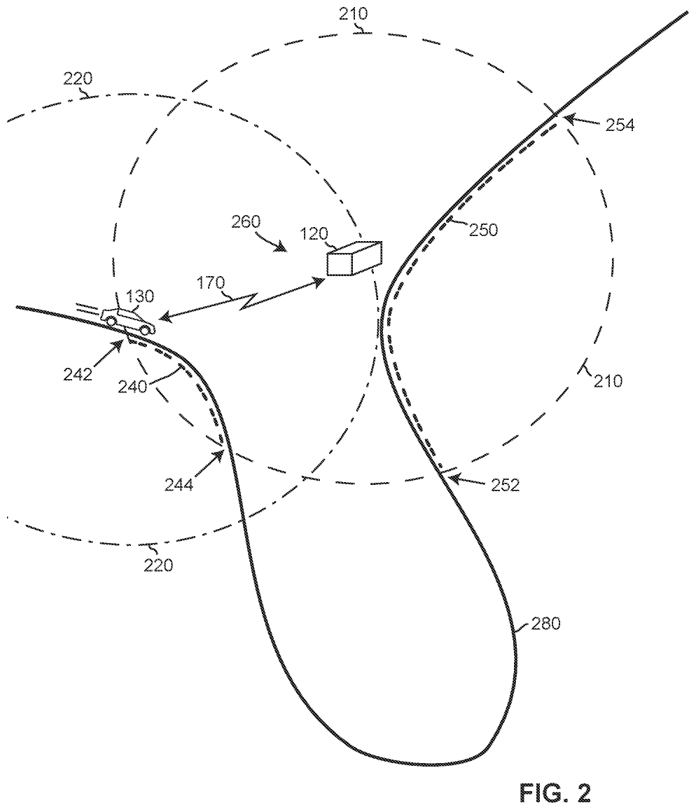

As discussed above, an RIRS is a portion of the road (e.g., 240, 250) where a mobile vehicle 130 can communicate with a remote equipment 120. An RIRS is a portion of the road where the transmission range (e.g., area of transmission, 210) of the remote equipment 120 overlaps the road, but also the portion of the road where the transmission range (e.g., 220) of the mobile vehicle 130 overlaps the remote equipment 120. The RIRSs along road 280 and communication between the mobile vehicle 130 and the remote equipment 120 are illustrated in FIGS. 2-7.

A transmission range 210 of the remote equipment 120 encloses an area of transmission represented by a two-dimensional circle. The transmission range 210 overlaps the road 280 in two areas, which are referred to as road in range segments (“RIRSs”). The first segment of overlap is the RIRS 240 and the second segment of overlap is RIRS 250. For the RIRS 240, the overlap of the transmission range 210 over the road 280 begins at the endpoint 242 and ends at the endpoint 244 or vice a versa depending on the direction of travel of the mobile vehicle 130. For the RIRS 250, the overlap of the transmission range 210 over the road 280 begins at the endpoint 252 and ends at the endpoint 254 or vice versa depending on the direction of travel of the mobile vehicle 130. While the mobile vehicle 130 is positioned in either the RIRS 240 or the RIRS 250, the remote equipment 120 may transmit data to the mobile vehicle 130. If the mobile vehicle 130 is positioned outside of the RIRS 240 and the RIRS 250, it is beyond the transmission range 210 of the remote equipment 120 and therefore cannot receive data from the remote equipment 120.

A transmission range 220 of the mobile vehicle 130 encloses an area of transmission that is also represented by a two-dimensional circle. In this example embodiment, the transmission range 220 is equal to, in area or distance from the center of the 2-D circle, to the transmission range 210. So, the RIRS 240 and the RIRS 250 also correspond to the segments of the road where the transmission range 220 overlaps the remote equipment 120. While the mobile vehicle 130 is positioned in either the RIRS 240 and the RIRS 250, the transmission range 210 overlaps the mobile vehicle 130 and the transmission range 220 overlaps the remote equipment 120, so the mobile vehicle 130 and the remote equipment 120 can transmit data to each other and receive data from each other, so the mobile vehicle 130 can communicate with the remote equipment 120. If the mobile vehicle 130 moves out of either the RIRS 240 or the RIRS 250, the transmission range 210 no longer overlaps the mobile vehicle 130 and the transmission range 220 no longer overlaps the remote equipment 120, so they cannot communicate with each other.

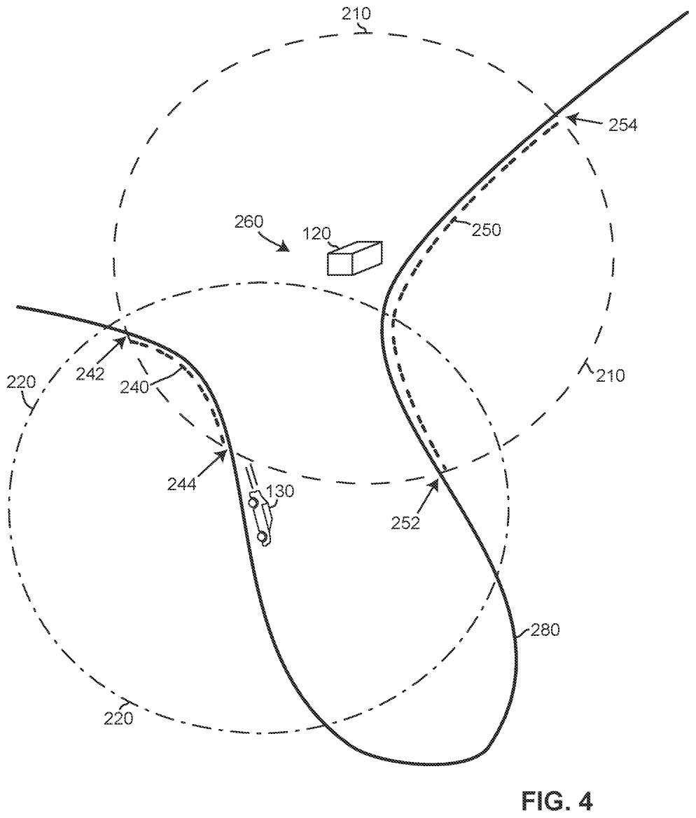

From the perspective of the mobile vehicle 130 with respect to the RIRS 240, the overlap of the transmission range 220 over the remote equipment 120 begins at the endpoint 242 and ends at the endpoint 244 or vice a versa if the mobile vehicle 130 is traveling in the opposite direction. With respect to the RIRS 250, the overlap of the transmission range 220 over the remote equipment 120 begins at the endpoint 252 and ends at the endpoint 254 or vice versa depending on the direction of travel of the mobile vehicle 130. So, for the direction of travel shown in FIGS. 2-7, the mobile vehicle 130 may begin to communicate with the remote equipment 120 when it reaches the endpoint 242 and enters the RIRS 240. As the mobile vehicle 130 travels through the RIRS 240, it can continue to communicate with the remote equipment 120 until it exits the RIRS 240 at the endpoint 244. Once the mobile vehicle 130 has driven past the endpoint 244, see FIG. 4, the mobile vehicle 130 and the remote equipment 120 can no longer communicate with each other.

The same applies to the RIRS 250 with its endpoints 252 and 254. Communication may begin when the mobile vehicle 130 enters the RIRS 250 at the endpoint 252 and continue until the mobile vehicle 130 exits the RIRS 250 at the endpoint 254

The length of an RIRS is the distance along the road between the endpoints of the RIRS. For example, the distance of the RIRS 240 is the distance along the road 280 between the endpoint 242 and the endpoint 244. The distance of the RIRS 250 is the distance along the road 280 between the endpoint 252 and the endpoint 254. The distance along the road of an RIRS may be referred to as the distance of an RIRS or by the acronym DofR. The distance (e.g., length) of an RIRS may be determined by identifying the endpoints of the RIRS and using map data to measure the distance along the road between the endpoints.

Knowing the distance of an RIRS (e.g., DofR) enables the mobile vehicle 130 to determine the amount of time that will be positioned in the RIRS and therefore the amount of time it has to communicate with the remote equipment 120. For example, if the mobile vehicle 130 has just entered the RIRS 250 at the endpoint 252, the mobile vehicle 130 knows that it can communicate with the remote equipment 120 during the entire time it takes to travel from the endpoint 252 to the endpoint 254. The mobile vehicle 130 can use the equation distance=rate*time to determine the amount of time available for communication. The mobile vehicle 130 may detect its speed of travel then use the following equation to determine the amount of time available for communication.

$$tAvail = DofR / rate \qquad Equation 1$$

Equation 2 represents the amount of time available for transmission and/or reception while the mobile vehicle 130 is positioned in an RIRS. The term tAvail stands for the amount of time available for communication between the mobile vehicle 130 and the remote equipment 120. The term DofR stands for the distance along the RIRS traveled by the mobile vehicle 130. The term rate stands for the speed of the mobile vehicle 130. For example, the amount of time available for communication while the mobile vehicle 130 traverses the RIRS 250 would be:

$$tAvail ( 250 ) = DofR ( 250 ) / rate \qquad Equation 2$$

In Equation 2, the term tAvail(250) stands for the amount of time available for communication while the mobile vehicle 130 is in the RIRS 250. The term DofR(250) stands for the distance along the road 280 between the endpoint 252 and the endpoint 254. Equation 2 may be used to calculate the amount of time available for any RIRS (e.g., 240, 250). The term rate stands for the speed of the mobile vehicle 130 as it traverses the RIRS 250.

The mobile vehicle 130 may also determine the amount of time that is available to communicate with the remote equipment 120 for all of the RIRSs combined along the road 280. The combined amount of time available for communication would be calculated as follows:

$$tAvail ( total ) = DofR ( total ) / rate \qquad Equation 3$$

In Equation 3, the term tAvail(total) stands for the total amount of time available for communication between the mobile vehicle 130 and the remote equipment 120 as the mobile vehicle 130 traverses the RIRS 240 and the RIRS 250 (e.g., all RIRSs of the remote equipment 120 along the road 280). The term DofR(total) stands for the total distance along the road 280 of the RIRS 240 and the RIRS 250. The term rate stands for the speed of the mobile vehicle 130 as it traverses the RIRS 240 and the RIRS 250. The value of tAvail(total) is merely the sum of the tAvail of Equation 1 for all RIRSs.

The mobile vehicle 130 may also calculate the amount of time that remains for communication as it travels along an RIRS. This calculation is useful if the mobile vehicle 130 does not maintain a constant speed while traveling through the RIRS. The mobile vehicle 130 may use information regarding its current geographic location and the amount of distance remaining to be traversed in the RIRS to determine the amount of time remaining for communication. The below equation may be used to calculate the amount of time remaining for communication:

$$tRemain ( 250 ) = D ( present to endpoint ) / rate \qquad Equation 4$$

In Equation 4, the term tRemain(250) stands for the amount of time left until the mobile vehicle 130 exits the RIRS 250 thereby precluding further communication between the mobile vehicle 130 and the remote equipment 120. The term D(present to endpoint) stands for the distance between the present geographic location of the mobile vehicle 130 in the RIRS 250 and the endpoint that marks the end of the RIRS 250 with respect to the direction of travel of the mobile vehicle 130. In the examples shown in FIGS. 2-7, the endpoint 254 represents the end of the RIRS 250 for the direction of travel shown in the figures. The term rate stands for the speed of the mobile vehicle 130.

Equation 4 may be evaluated multiple times as the mobile vehicle 130 travels through an RIRS to determine whether enough time remains to finish the transmission and/or reception. The mobile vehicle 130 may continuously monitor its speed and the remaining time available for communication as it traverses an RIRS. Since the speed of the mobile vehicle 130 affects the amount of time available for transmission and the amount of time remaining for transmission, monitoring the amount of time remaining will provide information as to whether the transmission and/or reception is likely to be successful.

4.1 Different Transmission Ranges

In the example discussed above and shown in FIGS. 2-7, the transmission range 210 of the remote equipment 120 is the same as the transmission range 220 of the mobile vehicle 130. There is no requirement that the transmission range of the remote equipment 120 and the transmission range of the mobile vehicle 130 vehicle be the same. If the transmission range of the remote equipment 120 is a same as the transmission range of the mobile vehicle 130, then the RIRSs identified for the remote equipment 120 will be the segments along the road in which the mobile vehicle 130 and the remote equipment 120 can transmit data to and receive data from each other. So, in the case in which the transmission ranges are the same, identifying an RIRS for the remote equipment 120 identifies an RIRS in which both the mobile vehicle 130 and the remote at 120 can fully (e.g., bidirectionally) communicate with each other.

When the transmission ranges of the remote equipment 120 and the mobile vehicle 130 are not the same, an RIRS can occurs only where the transmission range of the mobile vehicle 130 overlaps the remote equipment 120 and the transmission range of the remote equipment 120 overlaps the mobile vehicle 130 so that they can communicate with each other. When the transmission ranges are different, the overlap of the transmission range of the remote equipment 120 over the road 280 is not sufficient to define the RIRSs. When the transmission ranges are not equal, there may be some segments of the road where the mobile vehicle 130 can transmit data to the remote equipment 120, but cannot receive data from the remote equipment 120, and the remote equipment 120 can transmit data to the mobile vehicle 130, but cannot receive data from the mobile vehicle 130.

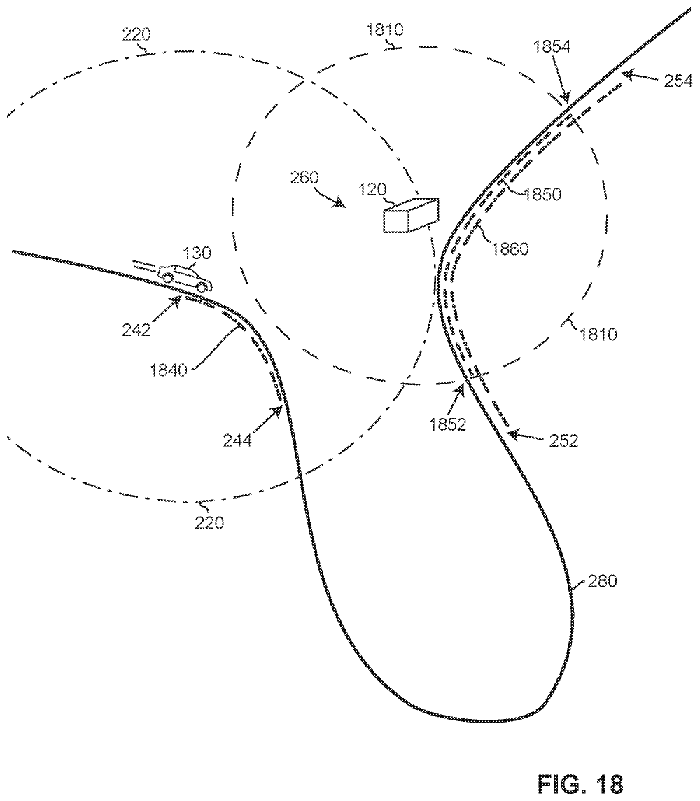

For example, referring to FIG. 18, a transmission range 1810 of the remote equipment 120 is smaller than the transmission range 220 of the mobile vehicle 130. As a result, along the segment 1840 of the road 280, the transmission range 1810 does not overlap the road, but the transmission range 220 overlaps the remote equipment 120. So, as the mobile vehicle 130 travels long the segment 1840, it can transmit data to the remote equipment 120, but cannot receive data from the remote equipment 120. Even though the mobile vehicle 130 can transmit data to the remote equipment 120, it cannot establish a wireless link with the remote equipment 120. The segment 1850 is an RIRS in which the mobile vehicle 130 and the remote equipment 120 can communicate. While the mobile vehicle 130 is positioned between the endpoint 1852 and the endpoint 1854, the transmission range 1810 of the remote equipment 120 overlaps the mobile vehicle 130 and the transmission range 220 of the mobile vehicle 130 overlaps the remote equipment 120, so the remote equipment 120 and the mobile vehicle 130 can communicate with each other. Along a segment 1860, between the endpoint 252 and the endpoint 1852 and between the endpoint 1854 and the endpoint 254, the mobile vehicle 130 can transmit data to the remote equipment 120, but cannot receive data from the remote equipment 120. The difference in the transmission ranges 1810 and 220 means that the only RIRS where the mobile vehicle 130 can communicate with the remote equipment 120 is the segment 1850.

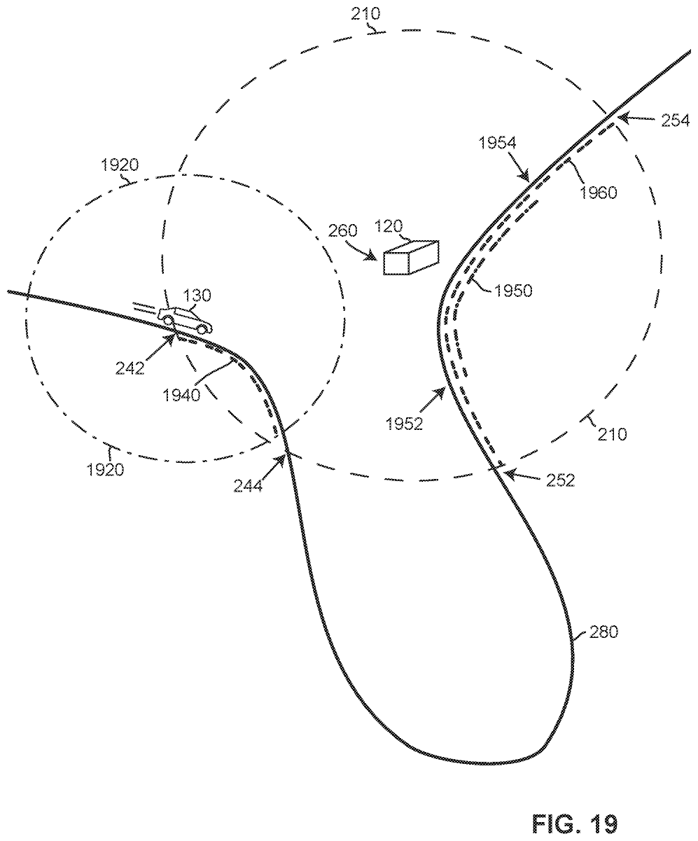

In another example, referring to FIG. 19, a transmission range 1920 of the mobile vehicle 130 is smaller than the transmission range 210 of the remote equipment. As a result, even though the transmission range 210 overlaps the road 280 along the segment 1940, the transmission range 1920 of the mobile vehicle 130 does not overlap the remote equipment 120 at any point as the mobile vehicle 130 travels along the segment 1940. So, as the mobile vehicle 130 travels along the segment 1940, it can receive data from the remote equipment 120, but cannot transmit data to the remote equipment 120. Even though the remote equipment 120 can transmit data to the mobile vehicle 130, it cannot establish a wireless link with the mobile vehicle 130. The segment 1950 is an RIRS in which the mobile vehicle 130 and the remote equipment 120 can communicate with each other. However, along a segment 1960, between the endpoint 252 and an endpoint 1952 and between an endpoint 1954 and 254, the remote equipment 120 can transmit data to the mobile vehicle 130, but cannot receive data from the mobile vehicle 130. The difference in the transmission ranges 1920 and 210 means that the only RIRS where the mobile vehicle 130 cannot communicate with the remote equipment 120 is the segment 1950.

The locations of the RIRSs along a road are determined by the locations where the transmission range of the remote equipment 120 overlaps the transmission range of the mobile vehicle 130. As discussed above, only while the mobile vehicle 130 is positioned in an RIRS can the mobile vehicle 130 transmit data to and receive data from the remote equipment 120 and vice a versa. The usefulness of the segments where the mobile vehicle 130 or the remote equipment 120 can transmit data, but not receive data is not fully considered here.

Even if the transmission range of the mobile vehicle 130 is not the same as the remote equipment 120, it is possible to determine the location of the RIRSs along any given road.

4.2 Static Determination of RIRSs

The locations of the RIRSs for the remote equipment (e.g., 120) and a particular road (e.g., 280), may be determined in advance and stored as map data (e.g., static determination) or as the mobile vehicle 130 is approaching the remote equipment (e.g., dynamic determination).

In the example embodiments of methods for determining the location of the RIRSs, it is assumed that the transmission range of the remote equipment is same as the transmission range of the mobile vehicle 130. When the transmission ranges are equal, the sections of the road overlapped by the transmission range (e.g., 210) of the remote equipment 120 defines the areas of the RIRS. Determining the RIRSs when the transmission range of the remote equipment is different than the transmission range of the mobile vehicle, involves additional steps. In the case that the transmission range of the remote equipment is not the same as the mobile vehicle, it may be most efficient for the mobile vehicle to calculate the RIRSs.

In performing a static determination of the RIRSs for a remote equipment and a road, a server or some other computer (e.g., vehicle computer 140, remote equipment computer 150) determines (e.g., calculates, identifies) the RIRSs for each remote equipment and the roads around each remote equipment. The calculations made be limited to certain remote equipment or certain roads as opposed to all known remote equipment. After the computer has determined the RIRSs, the RIRS data is stored as map data that can be accessed by the mobile vehicle 130 as it travels.

The computer determines the locations of the RIRSs using data such as the geographic location of the remote equipment, the geographic location of the roads around (e.g., proximate to, within transmission range of) the remote equipment, the transmission range of the remote equipment and the transmission range of the mobile vehicle 130. Other information that the computer may use to determine the locations of the RIRSs includes the geographic location of objects around the remote equipment that may obstruct transmissions between the remote equipment and the mobile vehicle 130.

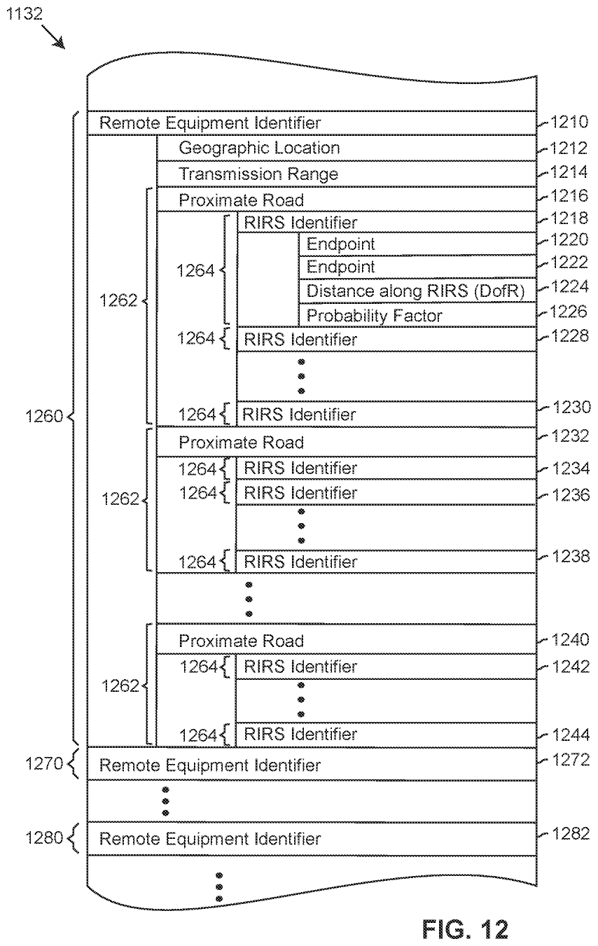

Data that may be used to determine the RIRSs for a remote equipment and a road may be stored in a database. An example embodiment of a database for storing remote equipment data is shown in FIG. 12. A remote equipment data 1132 includes a plurality of records (e.g., 1260, 1270, 1280). Each record pertains to a particular remote equipment 120. Each record includes one or more records 1262 for each road overlapped by the transmission range of the remote equipment. Each record 1262 includes one or more records 1264 for each RIRS created along the road by the transmission range of the remote equipment (transmission ranges equal).

In an example embodiment, the remote equipment data 1132 includes a record 1260. The record 1260 includes the remote equipment identifier 1210. The remote equipment identifier identifies the remote equipment (e.g., 120) for which the data of the record 1260 pertains. The record 1260 further includes the geographic location 1212 and the transmission range 1214 of the remote equipment 1210. The record 1260 further includes a plurality of the records 1262. Each record 1262 pertains to one road overlapped by the transmission range 1214 of the remote equipment 1210. In this example embodiment, the record 1260 includes one record of 1262 for the road 1216 (e.g., road 280), one record 1262 for road 1232 and one record 1262 for road 1240. The number of records 1262 depends on the number of roads overlapped by the transmission range 1214 of the remote equipment 1210.

Each record 1262 includes one or more records 1264. Each record 1264 pertains to a RIRS for the road of the record 1262. For example, the RIRS 1218, the RIRS 1228 and the RIRS 1230 of the respective records 1262 pertain to the road 1216. The RIRSs 1234, 1236 and 1238 respectively pertain to the road 1232. The RIRSs 1242 and 1244 respectively pertain to the road 1240.

Each record 1264 includes a RIRS identifier that identifies the RIRS (e.g., 1218, 1228, 1230). Each record 1264 further stores information regarding the RIRS such as a first endpoint 1220 (e.g., 242), a second endpoint 1222 (e.g., 244), and the distance of the RIRS (“DofR”). Each record 1264 may further include the probability factor 1226 for that RIRS. As discussed below, it is possible to determine a probability factor that covers an area that includes many RIRSs, but it is also possible to calculate a probability factor for each RIRS of each road for each remote equipment.

In an example embodiment, the server or computer performs the following operations for determining the data for the record 1260. The server or computer receives the remote equipment identifier 1210, the geographic location 1212 and the transmission range 1214 of the remote equipment 1210. The server or computer stores the identifier 1210, the geographic location 1212 and the transmission range 1214 in the record 1260. The server or computer uses map data to identify the roads that are overlapped by the transmission range 1214 of the remote equipment 1210. In this example, the server or computer identifies the roads 1216, 1232 and 1240 as being overlapped by the transmission range 1214 of the remote equipment 1210. The server or computer creates a record 1262 for each of the roads 1216, 1232 and 1240.

For each road, the server or computer uses map data to identify the portions of the road that are overlapped by the transmission range 1214. Each portion of the road is identified as a RIRS. A record 1264 is created for each RIRS of the road. For example, for the road 1216, the server or computer identifies the RIRS 1218, the RIRS 1228 and the RIRS 1230. For the road 1232, the server or computer identifies the RIRS 1234, the RIRS 1236 and the RIRS 1238. For the road 1240, the server or computer identifies the RIRS 1242 and the RIRS 1244.

For each RIRS identified, the server or computer uses map data, the geographic location 1212 and the transmission range 1214 of the remote equipment 1210 to identify the first endpoint 1220 and the second endpoint 1222 of the RIRS. Using map data, the server or computer may measure the distance along the road between the first endpoint 1220 and the second endpoint 1222 to determine the distance of the RIRS 1218 (e.g., DofR 1224). The server or computer stores the information in the record 1264 for the RIRS. The server or computer identifies respective the first endpoint 1220, the second endpoint 1222 and the DofR 1224 for each RIRS (e.g., 1228, 1230, 1234, 1236, 1238, 1242, 1244) and stores information in the appropriate record 1264.

The server or computer may also receive or calculate the probability factor 1226 for the RIRS. Each RIRS may include some aspects (e.g., geographic objects that affect transmission) that are unique to the RIRS, so a probability factor may be determined and recorded for each RIRS.

The server computer determines the information for each record 1264 and stores the record 1264 in the associated record 1262.

The remote equipment data 1132 further includes other records that pertain to other remote equipment, for example, record 1270 and record 1280. Record 1270 pertains to remote equipment 1272. Record 1280 pertains to remote equipment 1282. Records and 1270 and 1280 include information regarding their respective remote equipment (e.g., 1212, 1214) and one or more records 1262 for the roads proximate to the respective remote equipment. Each record 1262 of record 1270 and 1280 include one or more records 1264.

Once the server or computer has prepared the remote equipment data 1132, the database may be provided to the vehicle computer 140 of the mobile vehicle 130. Since there may be many mobile vehicles 130, the remote equipment data 1132 is provided to each mobile vehicle 130. The map data used to prepare the remote equipment data 1132 may be provided to each mobile vehicle 130 as the map data 1128.

As the mobile vehicle 130 travels, it may use the GPS receiver 1160 to determine its present geographic location. The mobile vehicle 130 may use the map data 1128 to determine the road it is traveling on and it is direction of travel. The mobile vehicle 130 may use the remote equipment data 1132, possibly in combination with the map data 1128, to identify proximate remote equipment, the roads proximate to the remote equipment and the RIRS associated with the remote equipment for each proximate road.

4.3 Dynamic Determination of RIRSs

As mentioned above, information regarding the RIRSs of remote equipment may be determined dynamically as the mobile vehicle 130 is driving. Dynamic determination of RIRSs is performed by the vehicle computer 140 of the mobile vehicle 130. The vehicle computer 140 may have information regarding the geographic location of the remote equipment and the transmission range of the remote equipment stored in its memory 1120. In an example embodiment, such information is stored in the map data 1128. In another example embodiment, the vehicle computer 140 stores the remote equipment data 1132 which includes records for remote equipment (e.g., 1260, 1270, 1280) but the records include only the remote equipment identifier (e.g., 1210, 1272, 1282), the geographic location (e.g., 1212) and the transmission range (e.g., 1214) for each of the respective remote equipment, but it does not contain any records 1262 or 1264.

In an example embodiment, vehicle computer 140 determines information regarding RIRSs for remote equipment as follows. The mobile vehicle 130 determines its present geographic location. In an example embodiment, the vehicle computer 140 includes the GPS receiver 1160. Since the vehicle computer 140 is connected to (e.g., carried by, part of) the mobile vehicle 130, the geographic location of the vehicle computer 140 and the mobile vehicle 130 coincide. The GPS receiver 1160 may determine and report the present geographic location of the mobile vehicle 130.

The vehicle computer 140 uses the present geographic location of the mobile vehicle 130 and the map data 1128 to identify the road on which it is traveling in the direction of travel. Having information regarding the road and direction of travel, the vehicle computer 140 determines the geographic locations of the remote equipment that lies ahead along the road. In an example embodiment, the vehicle computer 140 accesses the remote equipment data 1132 to access the geographic locations of the various remote equipment to identify the remote equipment that lie ahead. The vehicle computer 140 identifies the next proximate remote equipment that lies ahead on the road in the direction of travel.

Using the geographic location and transmission range of the next proximate remote equipment, the vehicle computer 140 determines the RIRSs for the next proximate remote equipment at least for the road on which the vehicle computer 140 is traveling. As discussed above, the vehicle computer 140 may easily determine RIRSs for a remote equipment when the transmission range of the mobile vehicle 130 is not the same as a transmission range of the remote equipment 120. The vehicle computer 140 may determine the RIRSs for all roads within the transmission range of the next proximate remote equipment and not just for the road that the mobile vehicle 130 is traveling. The vehicle computer 140 determines the endpoints and DofR for each RIRS that it identifies. The vehicle computer 140 may create one or more records 1260 to which each may have one or more records 1264 to store stores the data for the RIRSs in the remote equipment data 1132 discussed above.

The vehicle computer 140 may determine the RIRS information for remote equipment are positioned further away to cover the roads ahead that may be traveled by the mobile vehicle 130. The calculated information is stored in the remote equipment data 1132 and associated with the respective remote equipment.

The vehicle computer 140 may also calculate the probability factor (e.g., 1226) for each remote equipment. In another embodiment, the vehicle computer 140 stores a probability factor for each remote equipment that is applied to all RIRSs of the remote equipment as opposed to calculating or storing a probability factor for each RIRS. In another example embodiment, the vehicle computer 140 may store data for calculating a probability factor for each RIRS, a probability factor for groups of RIRSs, or a probability factor for all RIRSs.

The vehicle computer 140 may calculate and store RIRS in the remote equipment data 1132 for a plurality of remote equipment that the mobile vehicle 130 may drive past. If calculations are not time-consuming, the vehicle computer 140 may calculate the RIRS information for a remote equipment as it approaches the remote equipment, such that the vehicle computer 140 calculates and stores RIRS information only as the mobile vehicle 130 approaches the transmission range of remote equipment. When the vehicle computer 140 dynamically determines RIRS information, the RIRS may be stored temporarily in the remote equipment data 1132 and removed once the mobile vehicle 130 has exited the transmission range of the remote equipment. In an example embodiment, the vehicle computer 140 populates the remote equipment data 1132 as it travels and retains the RIRS data.

4.4 Variation of Dynamic Determination of RIRSs

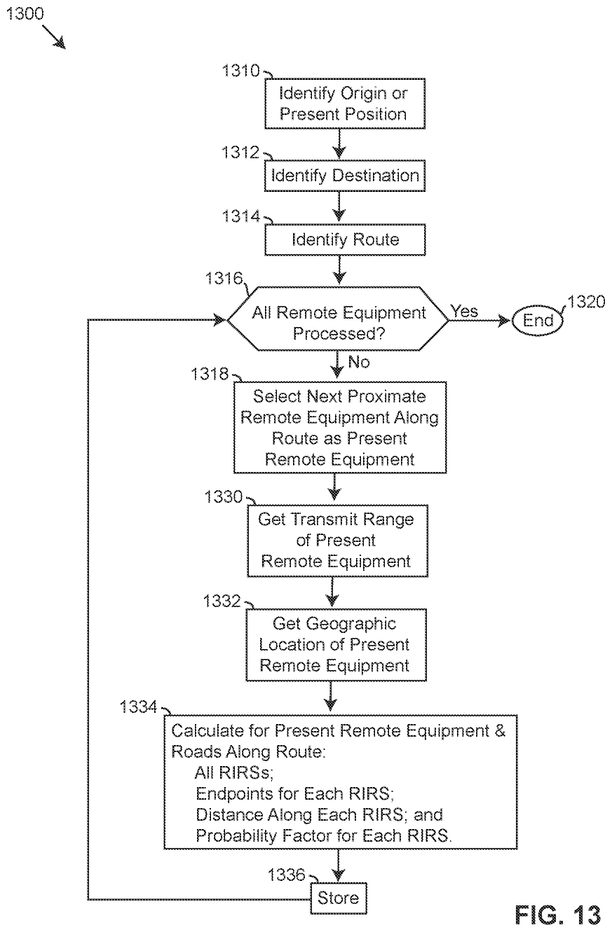

Another embodiment of a method for determining RIRS information dynamically, is shown in FIG. 13. The method 1300 for dynamically determining RIRS information includes operations identify origin 1310, identify destination 1312, identify route 1314, all 1316, select 1318, end 1320, get 1330, get 1332, calculate 1334 and store 1336. The flow of execution between the operations is identified in FIG. 13 by the lines with arrows between the various operations. The method 1300 may be performed by a server or the vehicle computer 140.

In identify origin 1310, the vehicle computer 140 determines the origin (e.g., starting point) of the trip being made by the mobile vehicle 130. The vehicle computer 140 may use the map data 1128 to identify its origin. In the situation where the mobile vehicle 130 is already started the trip or is performing method 1300 again, possibly due to a change in route or destination, the vehicle computer 140 may determine its present position as its starting point.

In identify destination 1312, the vehicle computer 140 identifies the destination of the mobile vehicle 130 or the terminus of its trip. The vehicle computer 140 may use the map data 1128 to identify its destination.

In identify route 1314, the vehicle computer 140 uses the map data 1128 to determine a route from its origin or present position to the destination. The vehicle computer 140 may use any technique for determining the route. In determining the route, the vehicle computer 140 determines the roads that will be traveled from the origin or the present geographic location to the destination. After the route and roads have been identified, the vehicle computer 140 identifies the remote equipment along the roads. The geographic locations and transmission ranges of the remote equipment may be stored in the map data 1128 or the remote equipment data 1132.

In all 1316, the vehicle computer 140 determines whether the RIRSs for all of the remote equipment identified in identify route 1314 have been determined. If one of the remote equipment identified in identify route 1314 has not been processed to determine its RIRS information, execution moves to select 1318. If all of the remote equipment identified in identify route 1314 have been processed, so that the RIRS information for all remote equipment along the route has been determined, execution moves to end 1320.

In select 1316, the mobile vehicle 130 identifies the next proximate remote equipment that lies along the route in the direction of travel. The next proximate remote equipment is referred to as the present remote equipment because its RIRS information will presently be calculated. After the RIRS information for the present remote equipment has been calculated, the remote equipment is identified as having been processed.

In get 1330 and get 1322, the vehicle computer 140 gets the transmission range and the geographic location of the present remote equipment. As discussed above, information regarding the remote equipment may be stored in the map data 1128 or the remote equipment data 1132. In another example embodiment, as the mobile vehicle 130 enters the first RIRS for the present remote equipment, the remote equipment computer 150 of the present remote equipment transmits its identifier 1026, its geographic location 1024 and its transmission range 1028 to the vehicle computer 140. The vehicle computer 140 uses the information from the present remote equipment to calculate the RIRS information for the present remote equipment. The vehicle computer 140 may also store the identifier 1026, geographic location 1024 and the transmission range 1028 in the remote equipment data 1132 along with the RIRS information that it calculates.

In calculate 1334, the vehicle computer 140 determines the RIRS information for the present remote equipment. If the transmission range of the present remote equipment overlaps multiple roads, calculate 1334 may determine the RIRS information for all roads covered by the present remote equipment or the RIRS information for only the roads that are part of the route determined in identify route 1314. The information calculated in 1334 may include all RIRSs for the present remote equipment, which includes respective endpoints for each RIRS and the DofR for each RIRS. Calculate 1334 may also determine or retrieve the probability factor for each RIRS. The vehicle computer 140 may store information in the memory 1120 that is useful for calculating the probability factor for an RIRS. Such information may be stored in a database that pertains to the remote equipment. The vehicle computer 140 may store pre-calculated probability factors for each remote equipment that may be used to determine the probability factor for each RIRS of the remote equipment.

In store 1336, the vehicle computer 140 stores the RIRS information calculated for the present remote equipment. The RIRS information may be stored in the remote equipment data 1132 as discussed above.

Each time the mobile vehicle 130 changes course or destination, method 1300 may be performed again. In the event that method 1300 is performed again, it may retain the RIRS information previously calculated.

In end 1320, execution of the method 1300 terminates.

4.5 Another Example Embodiment of Determining RIRSs

In another example embodiment of a method, the vehicle computer 140 performs, inter alia, the following operations. The vehicle computer 140 may perform the operations while the mobile vehicle 130 is driving along a road. The vehicle computer 140 selects a remote equipment as the present remote equipment. In performing this operation, the vehicle computer 140 selects one remote equipment from a plurality of remote equipment. Identifying the selected remote equipment as the present remote equipment identifies the remote equipment that is presently being processed.

Selecting the remote equipment may include determining the present geographic location of the mobile vehicle 130. Identifying the road that coincides with the present geographic location of the mobile vehicle 130. Determining the direction of travel of the mobile vehicle 130 along the road. Identifying one or more remote equipment ahead along the road in the direction of travel and selecting the closest remote equipment of the one or more remote equipment ahead along the road in the direction of travel as the present remote equipment.

The vehicle computer 140, determines the geographic location and the range of transmission of the present remote equipment. The information regarding the geographic location and range of transmission may be stored in the map data 1128, in another database related to remote equipment, or in the map data 1128. In an embodiment, determining the present location of the present remote equipment comprises accessing the remote equipment data 1132. Determining the transmission range of the present remote equipment comprises accessing the remote equipment data 1132.

Using the geographic location and range of transmission of the present remote equipment in combination with the map data 1128, the vehicle computer 140 identifies one or more segments of the road, along which the mobile vehicle 130 is traveling, that are overlapped by the transmission range (e.g., RIRSs) of the wireless transmitter of the present remote equipment. In an example embodiment, identifying the one or more RIRSs includes overlaying a geometric shape representing the transmission area (e.g., range) over the map data of the area surrounding the geographic location of the present remote equipment and identifying the one or more segments of the road that are overlapped by the geometric shape.

The vehicle computer 140 further determines a length (e.g., distance) of each segment along the road (e.g., DofR) of the one or more RIRS. In an example embodiment, determining the distance of each segment includes identifying the first endpoint on the road where the transmission range begins to overlap the road and the second endpoint on the road where the transmission range ceases to overlap the road with a continuous overlap between the first endpoint and the second endpoint and calculating (e.g., measuring) the distance along the road between the first endpoint and the second endpoint. The vehicle computer 140 may further store a description of the one or more RIRSs in the remote equipment data 1132. The description of an RIRS may include the geographic location of the first endpoint, the geographic location of the second endpoint and the distance along the road between the first endpoint and the second endpoint.

Because there may be a plurality of remote equipment along the road being driven by the mobile vehicle 130, the vehicle computer 140 may repeat the operations of selecting the remote equipment, determining a geographic location, determining a range of transmission, identifying one or more RIRS and determining a length of each segment (e.g., DofR) for each remote equipment positioned along the road.

### 5. Remote Equipment Computer

As discussed above, each remote equipment 120 includes a respective remote equipment computer 150. The remote equipment computer 150 may perform or control some or all the functions of the remote equipment 120. The remote equipment computer 150 may control the communication performed by the remote equipment 120. The remote equipment computer 150 may be physically attached to the remote equipment. If the remote equipment is mobile (e.g., electric machine), the remote computer 140 is physically attached to the remote equipment and moves with the remote equipment. If the remote equipment is not mobile (e.g., charging station), the remote equipment computer 150 need not be attached to the remote equipment, but it is physically co-located with the remote equipment.

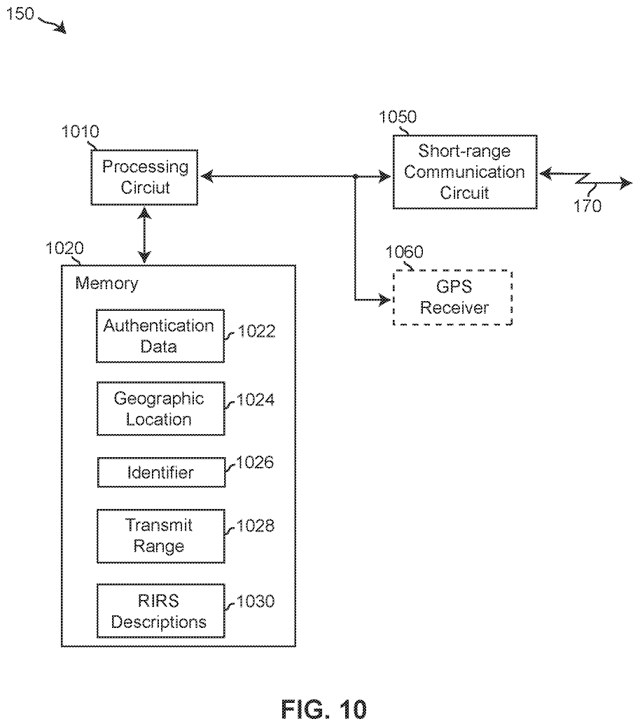

In an example embodiment, as best shown in FIG. 10, the remote equipment computer 150 includes processing circuit 1010, memory 1020, and short-range communication circuit 1050. The remote equipment computer 150 may further include the GPS receiver 1060. The memory 1020 may store the authentication data 1022, geographic location 1024 and identifier 1026. The memory 1020 may further include RIRS descriptions 1030 and transmission range 1028.

The processing circuit 1010 may include any type of circuit for processing data, controlling communication, and/or controlling some or all of the functions of the remote equipment 120. The processing circuit 1010 may include a microprocessor, a signal processor, a combination of circuits and/or devices for performing a function or controlling a function.

The short-range communication circuit 1050 may include any type of circuit for wireless short-range communication. The short-range communication circuit 1050 may be controlled in whole or in part by the processing circuit 1010. The processing circuit 1010 may receive data via the short-range communication circuit 1050. The processing circuit 1010 may transmit data via the short-range communication circuit 1050. The short-range communication circuit 1050 may communicate using any communication protocol. In an example embodiment, the short-range communication circuit 1050 may establish a wireless link 170 with the mobile vehicle 130 or other remote equipment 120 to communicate with the mobile vehicle 130 or other remote equipment 120. The short-range communication circuit 1050 may receive or transmit data via wireless broadcast. The receiver of the short-range communication circuit 1050 may detect the signal strength of an incoming signal.

The memory 1020 stores data for use by the processing circuit 1010 and/or the short-range communication circuit 1050. The memory 1020 may receive data from the processing circuit 1010 and/or the short-range communication circuit 1050 for storage. The memory 1020 may provide data to the processing circuit 1010 for transmission, processing and or calculations. The memory 1020 may store a fixed program for execution by the processing circuit 1010 to perform its functions. The memory 1020 may store data in any manner or structure. The memory 1020 may be implemented using any memory technology preferably nonvolatile memory.

The authentication data 1022 as discussed earlier, may be used to authenticate the remote equipment 120 to the mobile vehicle 130 and/or vice versa. The geographic location 1024 includes the map coordinates of the remote equipment 120. The map coordinates may be measured by survey and may be highly accurate. The geographic location 1024 may be transmitted to the mobile vehicle 130. The transmission range 1028 stores the transmission range of the short-range communication circuit 1050. Storing the transmission range 1028 in memory 1020 is optional. The transmission range 1028 may be transmitted to the mobile vehicle 130.

The RIRS descriptions 1030 includes information regarding each RIRS of the remote equipment 120 from the perspective of the remote equipment 120. If the transmit range of the mobile vehicle 130 is a same as the transmit range of the remote equipment 120, then the RIRSs of the remote equipment 120 will correspond to the RIRSs of the mobile vehicle 130. The information for each RIRS includes an RIRS identifier (e.g., 1218), the first endpoint (e.g., 1220), the second endpoint (e.g., 1222), and the DofR (e.g., 224). The information for each RIRS may further include a probability factor (e.g., 1224). The RIRS descriptions 1030 may be transmitted to the mobile vehicle 130. The RIRS descriptions 1030 may be transmitted to the mobile vehicle 130 with the identifier 1026, the geographic location, the transmit range of the remote equipment 120, formatted as a record similar to record 1260. The mobile vehicle 130 may store the information from the remote equipment 120 in the remote equipment data 1132.

The memory 1020 further stores the identifier 1026 which is the identifier that identifies the remote equipment. The identifier 1026 is the identifier (e.g., 1210) stored in the record (e.g., 1260) in the remote equipment data 1132 that relates to the remote equipment 120.

The GPS receiver 1060 may detect the geographic location of the remote equipment. The geographic location of the remote equipment as determined by the GPS receiver 1060 may be stored in the geographic location 1024. In the event that the value of the geographic location 1024 is highly accurate (e.g., determined by survey not GPS receiver), the position of the remote equipment as measured by the GPS receiver 1060 may be used to calculate correction data for differential GPS corrections. Differential GPS corrections may be transmitted to the mobile vehicle 130 so that the vehicle computer 140 may correct the information provided by GPS receiver 1160 to more accurately determine the present geographic location of the mobile vehicle 130.

### 6. Vehicle Computer

As discussed above, each mobile vehicle 130 includes a respective vehicle computer 140. The vehicle computer 140 may perform or control some or all the functions of the mobile vehicle 130. The vehicle computer 140 may control the communication performed by the mobile vehicle 130. The vehicle computer 140 is physically attached to the mobile vehicle 130 and moves with (e.g., carried by) the mobile vehicle 130.

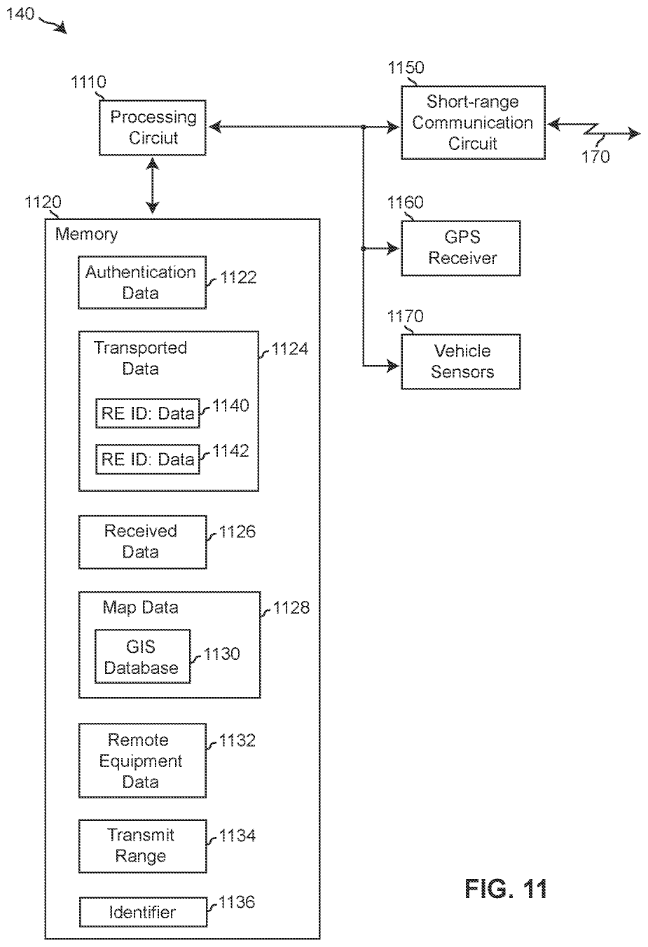

In an example embodiment, as best shown in FIG. 11, the vehicle computer 140 includes processing circuit 1110, memory 1120, short-range communication circuit 1150, vehicle sensors 1170 and GPS receiver 1160. The memory 1120 may store the authentication data 1122, transported data 1124, received data 1126, map data 1128, remote equipment data 1132, transmission range 1134 and identifier 1136.

Processing circuit 1110 may include any type of circuit for processing data, controlling communication, and/or controlling some or all of the functions of the mobile vehicle 130. The processing circuit 1010 may include a microprocessor, a signal processor, a combination of circuits and/or devices for performing a function or controlling a function.

The short-range communication circuit 1150 may include any type of circuit for wireless short-range communication. The short-range communication circuit 1150 may be controlled in whole or in part by the processing circuit 1110. The processing circuit 1110 may receive data via the short-range communication circuit 1150. The processing circuit 1110 may transmit data via the short-range communication circuit 1150. The short-range communication circuit 1150 may communicate using any communication protocol. In an example embodiment, the short-range communication circuit 1150 may establish the wireless link 170 with the remote equipment 120 or other mobile vehicle 130 to communicate with the remote equipment 120 or other mobile vehicle 130. The short-range communication circuit 1150 may receive or transmit data via wireless broadcast. The receiver of the short-range communication circuit 1150 may detect the signal strength of an incoming signal.

The memory 1020 stores data for use by processing circuit 1110, the vehicle sensors 1170, the GPS receiver 1160 and/or the short-range communication circuit 1150. The memory 1120 may receive data from the processing circuit 1110, the short-range communication circuit 1150, the vehicle sensors 1170 and/or the GPS receiver 1160 for storage. The memory 1120 may provide data to the processing circuit 1110 for transmission, processing and or calculations. The memory 1120 may store a fixed program for execution by the processing circuit 1110 to perform its functions. The memory 1120 may store data in any manner or structure. The memory 1120 may be implemented using any memory technology preferably nonvolatile memory.

The authentication data 1122 as discussed earlier, may be used to authenticate the mobile vehicle 130 to the remote equipment 120 and/or vice versa.

The transported data 1124 is data that has been received from a server and is physically transported by the mobile vehicle 130 as it drives around. The transported data 1124 is data that is intended to be transported to a remote location and transmitted to the remote equipment 120. The data stored in the transported data 1124 may be stored in records (e.g., 1140, 1142) that identifies the remote equipment that is intended to receive the data. For example, record 1140 includes the remote equipment identifier 1210 and the data that is intended to be transported and subsequently transmitted to the remote equipment 120 that has the identifier 1210. The record 1142 includes the remote equipment identifier 1282 and the data that is intended to be transported and subsequently transmitted to the remote equipment 120 that has the identifier 1282.

The received data 1126 stores the data that is transmitted from the remote equipment 120 to the mobile vehicle 130 for physical transport and subsequent transmission to the server. The data stored in the received data 1126 may also be stored in records that identify the remote equipment identifier that provided the data and/or the identifier of the intended recipient server.

The U.S. patent application Ser. No. 17/722,548 filed Apr. 18, 2022 and entitled “Methods and Apparatus for Transport and Transmission of Data to and from a Remote Location” contains additional information regarding the transport and transmission of data to and from remote locations and is incorporated herein by reference. It is disclosure may be used for any purpose including supporting claims of the present application.

The map data 1128 stores geographic data. Geographic data may include data that describes the geographic location of anything that may appear on a map, such as terrain, roads, bridges, buildings, intersections, remote equipment and/or geographic features (e.g., rivers, lakes, mountains, prominences). The geographic location of an object may be described as a coordinate (e.g., latitude-longitude, UTM, MGRS, OSGB36 National Grid). Map data may include altitude data. Map data may include a geographic information system (“GIS”) database 1130. The map data 1128 may include any data for the mobile vehicle 130 to relate its present geographic location to a road, a direction of travel, identify the geographic location of the remote equipment 120, determine distances such as distances between the endpoints along a road, and/or determine routes for travel. The map data 1128 may be implemented using any technology and/or any type of data (e.g., points, lines, polygons, vectors).

The remote equipment data 1132 stores information regarding remote equipment. An example embodiment of the remote equipment data 1132 is provided in FIG. 12 and discussed above. In an example embodiment, the remote equipment data 1132 stores a record (e.g., 1260, 1270, 1280) for each respective remote equipment 120 (e.g., 1210, 1272, 1282). When the remote equipment data 1132 is created using the above-described static process, the remote equipment data 1132 includes information (e.g., records 1262 and 1264) regarding each RIRS along each road that falls within the transmission range of each respective remote equipment 120. The static process may fully populate each record (e.g., 1260, 1270, 1280) of the remote equipment data 1132.

When the remote equipment data 1132 is created using any of the above described dynamic process, a record (e.g., 1260, 1270, 1280) may exist for each remote equipment 120 that includes the remote equipment identifier (e.g., 1210), the geographic location of the remote equipment 120 (e.g., 1212) and the transmission range of the remote equipment (e.g., 1214). As the mobile vehicle 132 drives around, it may use its present geographic location and the map data 1128 to create the records 1262 and 1264 as needed for one or more remote equipment 120. As the mobile vehicle 130 creates the records 1262 and 1264, it stores those records in the remote equipment data 1132 in the record (e.g., 1260, 1270, 1280) associated with the appropriate remote equipment 120 (e.g., 1210, 1272, 1282). Which means that some records (e.g., 1260, 1270, 1280) may have one or more records 1262 and 1264 while others do not.

The memory 1020 further stores the transmission range 1134 of the transmitter of the short-range communication circuit 1150. The transmission range 1134 of the mobile vehicle 130 may be used by the vehicle computer 140 to determine RIRSs for each remote equipment 120. The memory 1120 further stores an identifier 1136 which identifies that specific mobile vehicle 130.

The vehicle sensors 1170 detect physical information regarding the mobile vehicle 130. For example, the vehicle sensors 1170 may detect the speed of the mobile vehicle 130. The vehicle sensors 1170 may further detect atmospheric temperature outside of the mobile vehicle 130 and the signal strength of any radio signal that reaches the mobile vehicle 130.

The GPS receiver 1160 detects the present geographic location of the mobile vehicle 130. The GPS receiver 1160 may report the present geographic location of the mobile vehicle 130 to the processing circuit 1110. The processing circuit 1110 may use the present geographic location with the map data 1128 and/or the remote equipment data 1132 to determine information such as the road traveled by the mobile vehicle 130, the direction of travel, the closest remote equipment 120, the closest remote equipment 120 that lies along the road in the direction of travel, whether the mobile vehicle 130 is positioned in an RIRS of a remote equipment 120, and/or where in the RIRS the mobile vehicle 1130 is located (e.g., for determining the amount of time remaining).

### 7. Probability Factor

The probability factor (e.g.,1226) predicts the likelihood of something happening that affects the transmission of data. The probability factor may be applied to information used to predict the likelihood of successful transmission, such as the amount of time available for transmission, to better determine whether or not transmission will be successful. The probability factor may be used to determine occurrences that affect transmission such as variations in transmission signal strength, effects of Doppler shift, the effects of varying speed of the mobile vehicle 130, conditions that deteriorate transmission e.g., (obstacles that block transmission, weather, atmospheric conditions, atmospheric temperature, plants), competition between mobile vehicles 130 for bandwidth, and traffic density.

The probability factor may be determined based on the probability of a particular circumstance or a combination of circumstances that interferes with or deteriorates transmission and thereby the likelihood of successful transmission. A statistical model of the circumstances that may occur in the area of the remote equipment 120 may be used to determine the probability factor for many remote equipment 120, for one particular remote equipment 120 and/or RIRSs of the particular remote equipment 120.

Empirical data for many remote equipment 120, for one particular remote equipment 120 and/or RIRSs of a particular remote equipment 120 may be collected by a plurality of mobile vehicles 130 and used to determine the probability factor. Each mobile vehicle 130 that communicates with or attempt to communicate with one or more remote equipment 120 may record the conditions present during transmission and whether or not the transmission was successful. Empirical data may be reported to a server for determining probability factors.

One probability factor may be determined and applied to all remote equipment 120. A first probability factor may be determined and applied to a first group of remote equipment 120, a second probability factor may be determined and applied to a second group of remote equipment 120 and so forth. In the example embodiment of the remote equipment data 1132, a respective probability factor is calculated for each RIRS for each road of each remote equipment 120.

In an example embodiment discussed above, the probability factor is applied to the amount of time available for transmission by the mobile vehicle 130 while traveling through an RIRS to create an adjusted amount of time available for transmission. The adjusted amount of time available is used to determine whether transmission is likely to be successful. The probability factor may be applied to any aspect of transmission to include probabilistic factors in the calculation as to whether transmission will be successful. For example, the probability factor may be applied to transmit signal strength as perceived by recipient, the amount of expected retransmission, and the amount of expected errors in transmission.

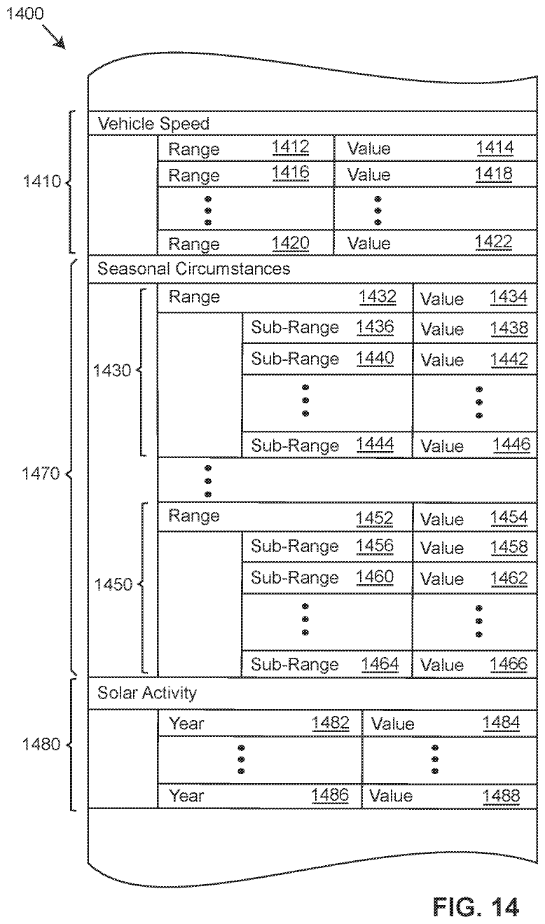

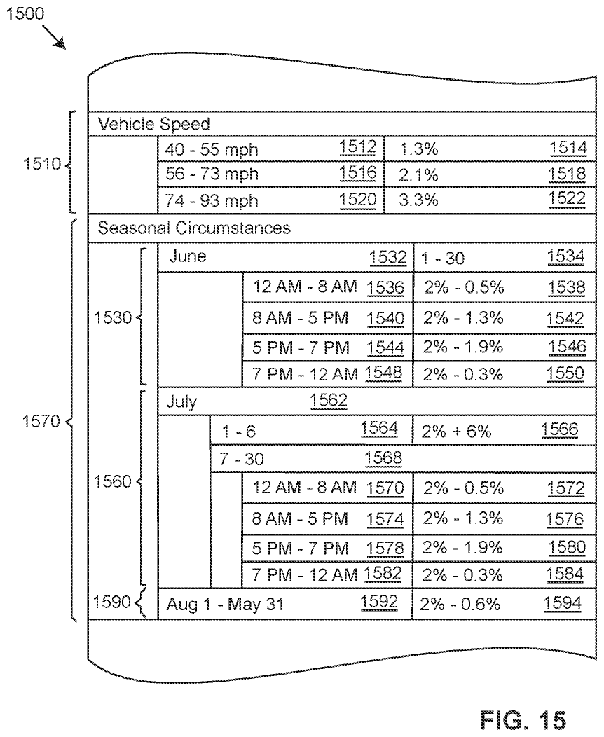

Probability data 1400, shown in FIG. 14, is an example embodiment of circumstances that affect transmission and the extent to which they may likely affect transmission. Probability data 1400 stores data of the likelihood of transmission error due to vehicle speed (e.g., record 1410), seasonal circumstances (e.g., record 1470) and solar activity (e.g., record 1480). Probability data 1400 may include additional records for other factors. A probability data 1500, shown in FIG. 15, is a specific implementation of the probability factor for vehicle speed and seasonal circumstances. The more concrete examples provided in the probability data 1500 aids in understanding the probability factor. The values of the probability factors in the probability data 1500 are applied to the amount of time available for transmission that is calculated by the mobile vehicle 130.

The possible effects of the speed of the mobile vehicle 130 on transmission are stored in record 1410. The speed of the mobile vehicle 130 is divided into ranges 1412, 1416 and 1420. The value of the probability factor for each range of speed is stored as value 1414, value 1418 and value 1422 respectively. In the probability data 1500, record 1510 stores the probability factors related to the speed of the mobile vehicle 130. The ranges 1512, 1516 and 1520 identify ranges of the speed of the mobile vehicle 130 of between 40 and 55 mph, 56 and 73 mph, and 74 and 93 mph respectively. The values 1514, 1518 and 1522 provide values for the probability factor that correspond to the ranges 1512, 1516 and 1522.

In the range 1512, the value of the probability factor 1514 is 1.3% which means that while the mobile vehicle 130 is traveling between 40 and 55 mph, there is likely to be a 1.3% reduction in the amount of time available for transmission. While the mobile vehicle 130 is traveling between 56 and 73 mph, and 74 to 93 mph, there is likely to be a 2.1% and a 3.3% reduction in the amount of time available for transmission. The value of the probability factor (e.g., 1514, 1518, 1522) includes the effect on transmission due to circumstances such as Doppler shift and/or radio signal interaction with objects that may block the transmission.

The possible effects of seasonal circumstances on transmission are stored in record 1470. In this example embodiment, calendar year is divided into range 1432 and range 1452. Each range, its associated sub-ranges and values are stored as a record (e.g., 1430, 1450). Range 1432 describes the range and value 1434 identifies the extent of the range. Sub-ranges 1436, 1440 and 1444 divide the range 1432. The values 1438, 1442 and 1446 provide respective values for the probability factor that correspond to the sub-ranges 1436, 1440 and 1444. The same hierarchy applies to record 1450.

In the probability data 1500, the record 1570 stores the probability factors related to seasonal circumstances. The record 1570 has three sub-records 1530, 1560 and 1590. In sub-record 1530, the range 1532 identifies the month of June and the value 1534 identifies the days 1 through 30 of the month of June. The sub-record 1530 includes sub-records 1536, 1540, 1544 and 1548. The sub-records identify ranges of time that correspond to a 24-hour day. The values 1538, 1542, 1546 and 1550 provide values for the probability factor that correspond to the ranges 1536, 1540, 1544 and 1548. The range 1536 identifies the time of day as being between 12 AM and 8 AM. The corresponding value 1538 for the probability factor is 2%+0.5%. The sum of the values, which is 2.5%, indicates that there will likely be a 2.5% reduction in the amount of time available transmission between 12 AM and 8 AM between June 1 and June 30. The ranges 1540, 1544 and 1548 divide the day into ranges of 8 AM to 5 PM, 5 PM to 7 PM and 7 PM to 12 AM. The values of the probability factors that correspond of these ranges are 3.3% (2%+1.3%), 3.9% (2%+1.9%) and 2.3% (2%+0.3%). So, between 8 AM and 5 PM there will likely be a reduction in the amount of time for transmission of 3.3%, between 5 PM and 7 PM a reduction of 3.9%, and between 7 PM and 12 AM a reduction of 2.3%.

The values 1538, 1542, 1546 and 1544 of the probability factors are affected by circumstances that occur during the days of June between the identified hours. The values for the probability factors may include circumstances such objects that block transmission, increased traffic, increased competition for transmission bandwidth due to increased traffic, or other circumstances. The values are expressed as a base (e.g., 2%) plus a variable amount (e.g., 0.5%, 1.3%, 0.9%, 0.3%). The base value represents the reduction in the amount of time available to transmit caused by circumstances that do not change (e.g., terrain, permanent obstacles). The variable amount represents the reduction in the amount of time available caused by circumstances that change with respect to the time of day. Between the hours of 12 AM and 8 AM, there is likely little traffic on the road so there is less interference due to traffic or competition for transmit bandwidth. Between 8 AM and 5 PM, interference increases due to increase traffic. The reduction in the amount of time available increases during the rush hour time of 5 PM to 7 PM. Between 7 PM and 12 AM there is less traffic, so the variable portion of the value of the probability factor is less.

So, during the month of June, the values of the probability factor are applied to adjust the amount of time available for transmission during the indicated times of the day.

The ranges and probability factors for the month of July are stored as sub-record 1560. The range 1562 identifies the month of July. Since no range value for the month of July is given, the range 1562 is construed as the entire month of July. The range in probability factors for the month of July are stored as sub-record 1560. However, July is subdivided differently than June. Range 1566 specifies that during the days of July 1 to July 6 (e.g., 1566), at any time of day, the value of the probability factor is 8% (e.g., 1568). The high probability factor may be due to a tremendous increase in traffic around the 4^{th} of July holiday. The remainder of the month of July, between July 7 and July 30 (e.g., 1568), the day is divided into ranges 1570, 1574, 1578 and 1582 that have corresponding values 1572, 1576, 1580 and 1584 for the respective probability factors. So, between July 7 and July 30, every day between 12 AM and 8 AM, 8 AM and 5 PM, 5 PM and 7 PM, and 7 PM and 12 AM the values of the probability factors are 2.4%, 3.1%, 3.3%, and 2.2% respectively.

The remainder of the year is described in the sub-record 1590. The range 1592 specifies the range of August 1 through May 31. In that range, the value for the probability factor is 2.6% (e.g., 1594). So, the value of the probability factor is 2.6% for every day between August 1 and May 31 regardless of the time of day.

The possible effects of solar activity on transmission are stored in record 1480. Solar activity fluctuates on an 11-year cycle. The 11-year cycle is divided by year, so range 1482 through range 1486 apply to one year. The values of the probability factor 1484 and 1488 correspond to the ranges 1482 and 1486 respectively. The probability data 1500 does not include an example of record 1480 for solar activity.

Probability data may be organized in any format, use any ranges, expressed the value of the probability factor in any way. When the value of a probability factor is needed, the processing circuit 1110 of the vehicle computer 140 accesses the probability data to determine the value should be applied to whatever factor affects transmission. The adjusted value is used to further determine the likelihood of successful transmission. Probability data (e.g., 1400, 1500) may be stored in the memory 1120.

The probability data 1400 or 1500 may apply to all remote equipment 120. In the event that probability a 1400 1500 applies to all remote equipment 120, then the probability data does not need to be related to specific remote equipment 120. The probability data 1400 and 1500 do not identify remote equipment (e.g., no remote equipment identifier), so the values for the probability factors are suitable for determining a single probability factor for all remote equipment. If the probability data relates to groups of remote equipment 120 or individual remote equipment 120, then a respective probability data 1400 or 1500 may be developed for each group or each individual remote equipment. If the probability data is to be applied to groups of RIRSs or individual RIRSs, then a respective probability data 1400 or 1500 may be developed for each group of RIRSs or individual RIRSs.

### 8. Applying the Probability Factor

In the example embodiment of the probability data 1500, the probability factors are applied to the amount of time available for transmission. For this example embodiment, the probability factor is applied as follows.

The mobile vehicle 130 is traveling down the road 280. Assume for this example that the remote equipment data 1132 includes all of the information regarding the RIRSs for the remote equipment 120 (e.g., static calculation). The GPS receiver 1160 informs the mobile vehicle 130 of its present geographic location. The vehicle computer 140 uses the present geographic location along with the map data 1128 to determine that the mobile vehicle 130 is traveling on the road 280. The vehicle computer 140 uses the present geographic location along with the remote equipment data 1132 to determine that the mobile vehicle 130 is about to enter the RIRS 250 via the endpoint 254 (the direction opposite the direction shown in FIGS. 2-7). Since the transported data 1124 stores data intended for transfer to the remote equipment 120, the vehicle computer 140 calculates the amount of time available while traversing the RIRS 250 to transmit the data.

In order to do the calculation, the vehicle computer 140 determines the speed of the mobile vehicle 130. The present speed of the mobile vehicle 130 may be determined using the vehicle sensors 1170 and/or the GPS receiver 1160. The vehicle computer 140 accesses the remote equipment data 1132 to get the distance of the RIRS (e.g., DofR 1224). The vehicle computer 140 uses Equation 1 to calculate the amount of time that will take the mobile vehicle 132 pass through the RIRS 250. Assume for this example that DofR is 0.5 miles and the speed (e.g., rate) is 43 mph. Using Equation 1, it will take the mobile vehicle 130 about 41.86 seconds to traverse the RIRS 250, so tAvail is 41.86 seconds.

The vehicle computer 140 accesses the probability data 1500 to determine the value of the probability factor they should be applied to tAvail to account for the more random circumstances that could occur. The vehicle computer 140 first accesses record 1510 of the probability data 1500. The vehicle computer 140 knows that the present speed of the mobile vehicle 130 is 43 mph, so the vehicle computer 140 accesses the value 1514 because it corresponds to the range 1512. The value of the probability factor in 1514 is 1.3%, so the vehicle computer 140 knows that the value of 1.3% will need to be applied to tAvail. The vehicle computer 140 also accesses record 1570. The vehicle computer 140 maintains a calendar, and knows that the present date is July 4. Accordingly, the vehicle computer accesses range 1566 to get the value of the probability factor 1568, whose value is 8%.

The vehicle computer 140 sums the values of the probability factors read from the probability data 1500. So, the final value of the probability factor that should be applied to tAvail is 9.3% (1.3%+8%). The vehicle computer 140 then uses the below Equation 5 to calculate the adjusted value for tAvail.

$$tAvailAdjusted ( 250 ) = tAvail - ( {tAvail}^{*} ProbabilityFactor ) \qquad Equation 5$$

The term tAvailAdjusted(250) stands for the adjusted tAvail for the RIRS 250. The term tAvail stands for the value determined by Equation 1 (41.86 seconds). The term ProbabiltyFactor is the final probability factor (e.g., 9.3%) read from the probability data 1500. In this example embodiment, the probability factor reduces the amount of time available for transmission by the value of the probability factor. Equation 5 is evaluated for the above values as follows:

$$tAvailAdjusted ( 250 ) = 4186 s - ( {( 41 \; 86 )}^{*} ( 0.09 3 ) ) \qquad Equation 5 Evaluated$$

So the value for tAvailAdjusted(250) is 37.97 seconds, so almost 4 seconds are lost to the probabilistic circumstances that interfere or degrade transmission. The vehicle computer 140 can use the tAvailAdjusted(250) to determine whether there is enough time for it to transmit the data from the transported data 1124. If tAvailAdjusted(250) is sufficient to transmit the data, then the transmission will highly likely be successful because the maximum amount of time, tAvail, has been adjusted to account for circumstances that may (e.g., probabilistically) affect transmission. If tAvailAdjusted(250) is not sufficient to transmit the data, then the transmission will highly likely be unsuccessful. There is a possibility that if tAvailAdjusted(250) is close to being sufficient, the transmission might be successful because all of the circumstances that might degrade transmission by 9.3% may not be present.

If the likelihood of retransmission or amount of data that might need to be retransmitted is considered, the impact of the probability factor on tAvail may be much higher than the examples given here. The amount of data that might need to be retransmitted may be accounted for by increasing the amount of data (e.g., amount of available data) in Equation 6 or the value of the probability factor.

9. Data Transmission from Mobile Vehicle to Remote Equipment

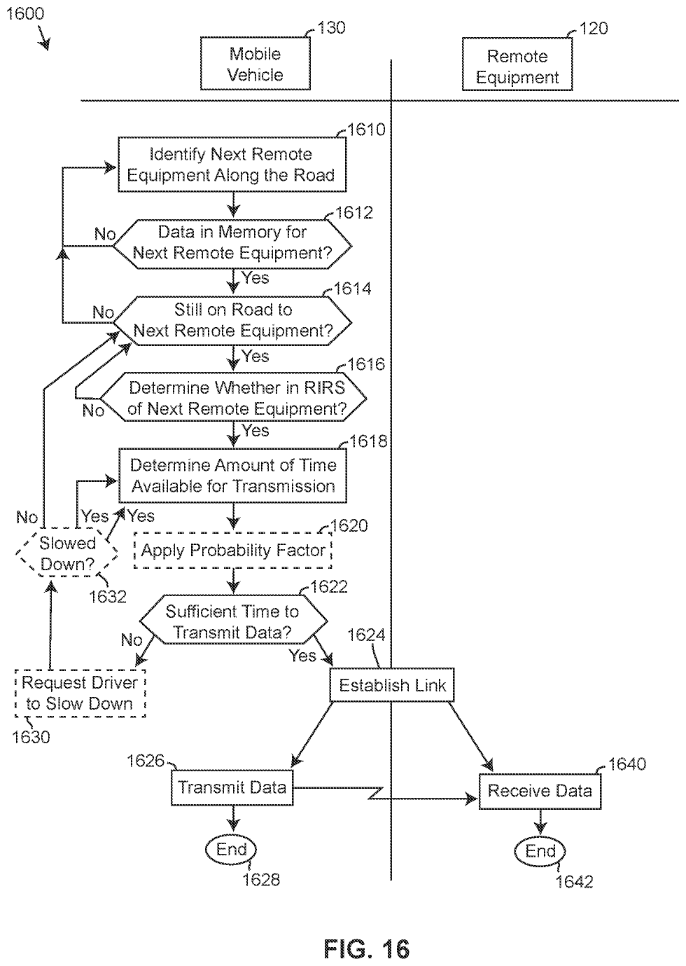

The method 1600, shown in FIG. 16, is an example embodiment of a method for the mobile vehicle 130 to transmit data to the remote equipment 120. The method 1600 includes operations that are performed by the mobile vehicle 130 and the remote equipment 120. The operations performed by the mobile vehicle 130 include identify 1610, data 1612, still 1614, determine 1616, determine 1618, apply 1620, sufficient 1622, establish 1624, transmit 1626 and end 1628. The operations request 1630 and slowed 1632 are optional operations that may be performed by the mobile vehicle 130. The operations performed by the remote equipment 120 include establish 1624 receive 1640 and end 1642. The order of execution of the various operations is shown in FIG. 16.

In identify 1610, the vehicle computer 140 identifies the next remote equipment that lies along the road in the direction that it is traveling. The GPS receiver 1160 may determine the present geographic location of the mobile vehicle 130. The processing circuit 1110 using the present geographic location along with the map data 1128 and/or the remote equipment data 1132 two determine which remote equipment is positioned next along the road being traveled and in the direction being traveled. The processing circuit 1110 uses the present geographic location to extract the identifier (e.g., 1210 1272, 1282) from the remote equipment data 1132 that pertains to the next remote equipment 120.

In an example embodiment, the next remote equipment 120 includes a closest remote equipment of one or more remote equipment that lie ahead along the road in the direction of travel. In another example embodiment, identify 1610 includes identifying the present geographic location of the mobile vehicle 130, identifying one or more remote equipment that lie ahead along the road in the direction of travel that have a wireless transmission range that overlaps the road (e.g., RIRSs), and selecting the closest remote equipment of the one or more remote equipment as the next remote equipment.

In data 1612, the processing circuit 1110 determines whether the transported data 1124 stores data intended for transfer to the next remote equipment identified in the operation identify 1610. The processing circuit 1110 uses the remote equipment identifier from the operation identify 1610 to determine whether any data intended for the next remote equipment has been stored in the transported data 1124. In an example embodiment, data 1612 includes determining that the data in the transported data 1124 includes the identifier of the next remote equipment.

In still 1614, the vehicle computer 140 determines whether the mobile vehicle 130 is still traveling on the road toward the next remote equipment 120. The vehicle computer 140 may get the present geographic location of the mobile vehicle 130 from the GPS receiver 1160. The processing circuit 1110 may use the present geographic location in conjunction with the map data 1128 to determine whether the mobile vehicle 130 is still on the road. The processing circuit 1110 may use the remote equipment data 1132 to determine whether the road that it is on leads to the next remote equipment. If the mobile vehicle 130 changes course or takes a different road, the vehicle computer 140 move execution to identify 1610 to identify a different remote equipment as the next remote equipment along the new course or the different road.

In determine 1616, the vehicle computer 140 determines whether the mobile vehicle 130 is positioned in an RIRS of the next remote equipment 120. The processing circuit 1110 may use the map data 1128 and the remote equipment data 1132 to determine whether the present geographic location of the mobile vehicle 130 coincides with an RIRS. The processing circuit 1110 may determine that the mobile vehicle 130 is positioned in an RIRS by using the present geographic location and the map data 1128 to determine that the mobile vehicle 130 is positioned on the road (e.g., 1216) of the RIRS (e.g., 1218) between the first and point (e.g., 1220) and the second endpoint (e.g., 1222).

In an example embodiment, determine 1616 includes determining the present geographic location of the vehicle and determining that the present geographic location of the vehicle coincides with a segment of the road that is overlapped by the wireless transmission range of the next remote equipment. Determine 1660 may further include determining that the mobile vehicle is positioned between a first endpoint (e.g., 1220) and a second endpoint (e.g., 1222) of the RIRS (e.g., 1218)

In determine 1618, the vehicle computer 140 determines the amount of time available for transmission (tAvail). The vehicle computer 140 uses Equation 2 to calculate tAvail if the mobile vehicle 130 will transit the entire RIRS (e.g., 250) between the first endpoint (e.g., 252) and the second endpoint (e.g., 254). The vehicle computer 140 uses Equation 4 to calculate the amount of time remaining for transmission (e.g., tRemaining) if the mobile vehicle 130 has passed the first endpoint (e.g., 252) before beginning communication and will traverse only a portion of the RIRS (e.g., 250) while attempting to communicate.

In an example embodiment, determine 1618 includes determining a distance along the road (e.g., DofR) between the present geographic location of the mobile vehicle 130 and the end of the segment of the road where the wireless transmission range of the next remote equipment no longer overlaps the road, determining the speed of the mobile vehicle 130 and dividing the distance by the speed to determine the amount of time (e.g., tRemaining) available for transmission.

In apply 1620, the vehicle computer 140 accesses and/or calculates the value of the probability factor for the circumstances of the mobile vehicle 130 and/or the RIRS and applies the probability factor to either tAvail or tRemaining. The operation apply 620 is shown in dashed lines because it is an optional operation. If the vehicle computer 140 does not execute apply 1620, then the value for tAvail or tRemaining is used in the operation sufficient 1622. If the vehicle computer 140 does execute apply 1620, then the adjusted value (e.g., value adjusted by applying the probability factor) for tAvail or tRemaining are used in the operation sufficient 1622.

In sufficient 1622, the vehicle computer 140 determines whether the amount of time available for transmission (e.g., tAvail, tRemaining, tAvailAdjusted, tRemainingAdjusted) is sufficient to transmit the amount of data intended for transfer to the remote equipment 120. Sufficient 1622 may determine the amount of time it will take to transmit the data then compare it to the amount of time available. The amount of time needed to transmit the data may be calculated as follows:

$$tXfer = ( Amount of Available Data ( bits ) ) / Bit Rate ( bits / sec ) \qquad Equation 6$$

The term Amount of Available Data (bits) stands for the amount of data that is available to transmit to the remote equipment 120. The term (bits/sec) stands for the rate at which the data can be transmitted by the short-range communication circuit 1150. The term tXfer is the amount of time that will take to transmit the amount of available data at the bit rate in seconds.

If the time available for transmission (e.g., tAvail, tRemaining, tAvailAdjusted, tRemainingAdjusted) is greater than the amount of time required to transmit (e.g., tXfer), then the likelihood that the transmission will be successful is high. If the time available for transmission is less than or equal to the time required to transmit, then the likelihood that transmission will be successful is low. In sufficient 1622, if the time required is less than the time available, then there is likely sufficient time to transmit the data.

In Equation 6, the Amount of Available Data may include the amount of data that required for overhead for the communication protocol being used and possibly a factor to account for the need to re-transmit data. In other words, the amount of data stored in the transported data 1124 intended for transfer to the remote equipment 120 may be increased to account for communication protocol overhead and possible retransmission of data was not received.

In establish 1624, the vehicle computer 140 and the remote equipment computer 150 establish a communication link (e.g., 170) with each other. An estimated amount of time that it may take to establish the link may also be accounted for in Equation 6.

In transmit 1626, the vehicle computer 140 transmits the data to the remote equipment 120. Transmission includes transmission of all overhead bits for the communication protocol which may include acknowledgments and retransmissions.

In receive 1640, the remote equipment computer 150 receives the data from the vehicle computer 140.

End 1628 and 1642 represent completion of the method 1600.

In request 1630, an optional operation, the vehicle computer 140 requests the driver to slow down. Request 1630 may be executed when sufficient 1622 determines that there is not enough time to transmit the data. The vehicle computer 140 may present the request on a display for the driver to read and/or may activate a sound. The driver is not required to comply.

In slowed 1632, the vehicle computer 140 determines whether the driver has slowed down responsive to request 1630. If the driver slows down, then execution moves to determine 1618 to recalculate the amount of time available for transmission. If the driver is not slowed, then execution operation moves to still 1614. If request 1630 and slowed 1632 are omitted from the method 1600, then when there is not enough time to transmit the data, execution moves from sufficient 1622 to still 1614.

10. Data Transmission from Remote Equipment to Mobile Vehicle

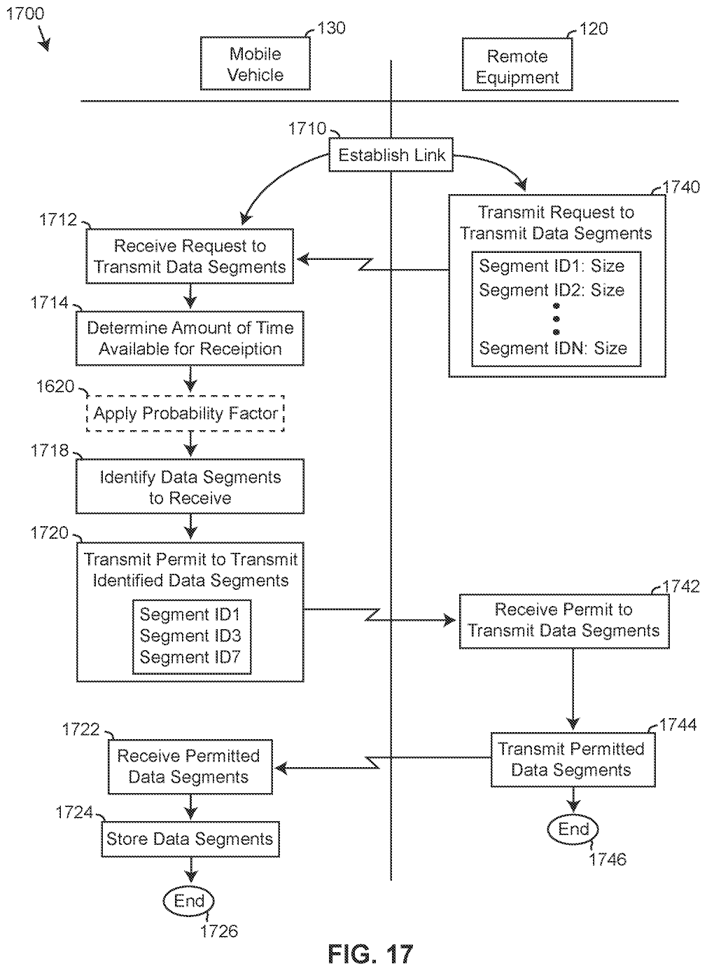

The method at 1700, shown in FIG. 17, is an example embodiment of a method for the remote equipment 120 to transmit data to the mobile vehicle 130. The method 1700 includes operations that are performed by the mobile vehicle 130 and the remote equipment 120. The operation performed by the mobile vehicle 130 include establish 1710, receive 1712, determine 1714, apply 1620, identify 1718, transmit 1720, receive 1722, store 1724 and end 7026. The operations performed by the remote equipment 120 include establish 1710, transmit 1740, receive 1742, transmit 1744 and end 1746.

In establish 1710, the vehicle computer 140 and the remote equipment computer 150 establish a communication link (e.g., 170).

In transmit 1740, the remote equipment computer 150 transmits a request to the vehicle computer 140. The request requests that the vehicle computer 140 receive data from the remote equipment computer 150. The remote equipment computer 150 has no information as to the location of the mobile vehicle 130 with respect to the RIRS where the mobile vehicle 130 is located or the speed of the mobile vehicle 130, so the remote equipment computer 150 cannot determine how much time is available for transmission. So, the request identifies the data that the remote equipment computer 150 has available for transmission. In an example embodiment, data available for transmission is identified by a segment identifier and the size (e.g., bytes, bits) of the segment.

In receive 1712, the vehicle computer 140 receives the request from the remote equipment 120.

In determine 1714, the vehicle computer 140 determines the amount of time available for reception. Determine 1714 is the same as determine 1618, but the time that is available will be used by the vehicle computer 140 for reception of data rather than for the transmission of data. In determining the amount of time available for reception, determine 1714 may account for the amount of time required to transmit overhead associated with communication protocol the amount of retransmission and the time required for that the vehicle computer 140 and the remote equipment computer 150 to execute the method 1700. In an example embodiment, determine 1714 includes determining the amount of time the mobile vehicle 130 will be positioned in the RIRS. In another example embodiment, determine 1714 includes determining an amount of time the mobile vehicle 130 will be positioned in all remaining RIRSs of the remote equipment 120 in the direction of travel.

Apply 1620, discussed above, may be executed by the vehicle computer 140 as part of the method 1700.

In identify 1718, the vehicle computer 140 determines the segments of data that it may receive from the remote equipment computer 150 during the amount of time available for reception. The vehicle computer 140 has already determined the amount of time available for reception (e.g., tAvail, tRemaining, tAvailAdjusted, tRemainingAdjusted). The vehicle computer 140 uses Equation 6 to determine the amount of time required to transmit each segment of data. The vehicle computer 140 compares sums of the time required for various combinations of the segments to identify which segments can be transmitted by the remote equipment computer 150 and received by the vehicle computer 140 in the amount of time available. The vehicle computer 140 identifies those segments whose time required for transmission is less than the amount of time available for transmission.

In an example embodiment, identify 1718 includes dividing the amount of data for each segment by a rate of transmission of the data to determine the respective amount of time for transmission of each segment of data and identifying a combination of the segments of data whose respective times for transmission sum to an amount that is less than the amount of time available for reception.

In transmit 1720, the vehicle computer 140 transmits a permit to transmit data to remote equipment computer 150. The permit to transmit data includes the segment identifier of those segments that the remote equipment computer 150 is allowed to transmit. The segments identified in transmit 1720 are those that can be transmitted in the time available for transmission.

In receive 1742, the remote equipment computer 150 receives the permit from the vehicle computer 140.

In transmit 1744, the remote equipment computer 150 transmits the data segments identified in the permit to the vehicle computer 140.

In receive 722, the vehicle computer 140 receives the permitted data segments from the remote equipment computer 150.

In store 1724, the vehicle computer 140 stores the received data segments in the receive data 1126.

The method 1700 ends with end 1726 and end 1746.

### 11. Determining a Geographic Location for Remote Equipment

The geographic location for placing remote equipment may be selected to increase or decrease the number and distance of the RIRSs. As discussed above, when the remote equipment 120 is positioned at geographic location 260, as shown in FIGS. 2-7, the overlap of the transmission range 210 over the road 280 creates the RIRS 240 and the RIRS 250, assuming that the transmission range 220 is equal to the transmission range 210. If the remote equipment 120 is positioned at geographic location 860, the length of the RIRS 240 is increased by a distance 820 while the net loss to the distance of the RIRS 250 is about zero. Positioning the remote equipment 120 at geographic location 860 increases the total distance (e.g., length) of the RIRS 240 and 250 as compared to the total distance when the remote equipment 120 is positioned at the geographic location 260. Having greater distance means that the geographic location 860 provides the advantage of a greater amount of time available for transmission.

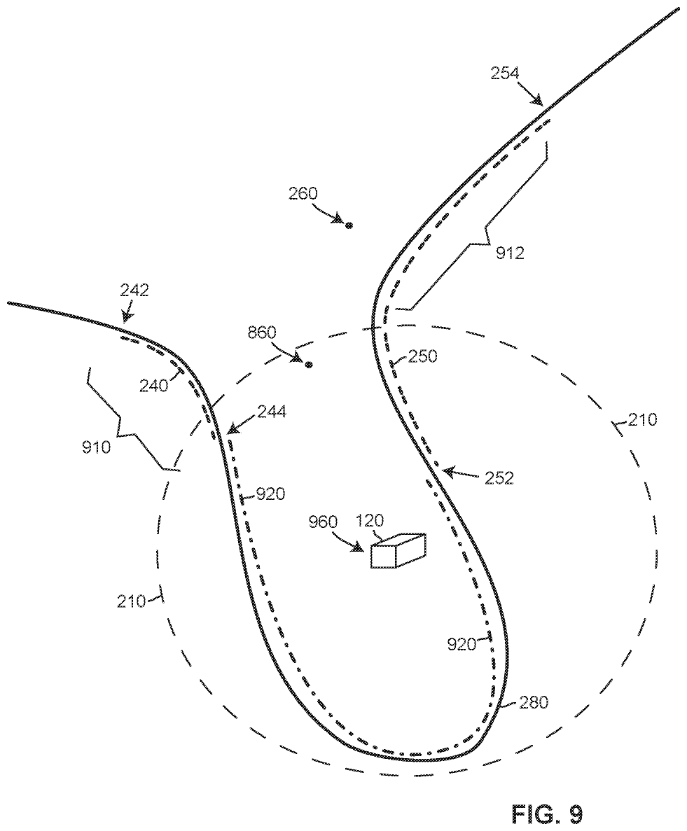

However, when the remote equipment 120 is positioned at a geographic location 960, as shown in FIG. 9, a distance 920 that is added is significantly greater than a distance 910 and a distance 912 that are lost. Positioning the remote equipment 120 at the geographic location 960 provides greater RIRS distance (e.g., DofR) and therefore an even greater amount of time available for transmission. If at all possible, the remote equipment 120 should be placed at the geographic location 960 as opposed to geographic locations 860 or 260.

An example embodiment of a method for selecting the geographic location for positioning a charging station includes for each geographic location of a plurality of geographic locations: (1) identifying a road that at least partially lies within a transmission range of a wireless transmitter of the charging station while positioned at the geographic location; (2) identifying one or more segments (e.g., RIRSs) along the road that are overlapped by the transmission range of the wireless transmitter of the charging station; (3) calculating a distance along the road for each of the one or more segments (e.g., DofR); and (4) summing the distance of each of the one or more segments to determine a total distance of all segments along the road for the geographic location; and positioning the charging station at the geographic location of the plurality of geographic locations that provides a greatest total distance.

Identifying the road includes overlaying the geometric shape representing the transmission range (e.g., 2-D circle) over a map data of an area surrounding the geographic location, identifying one or more roads that are overlapped by the geometric shape (e.g., identifying RIRSs), and selecting one of the one or more roads. One segment (e.g., RIRS) of the one or more segments (e.g., RIRSs) along the road comprises a first endpoint on the road where the transmission range begins to overlap the road and a second endpoint on the road where the transmission range ceases to overlap the road and the transmission range continuously overlaps the road between the first endpoint and the second endpoint.

### 12. Long-Range Communication

A long-range network or long-range communication network refers to a network capable of communicating (e.g., transmitting, receiving) data (e.g., information) over distances measured in tens of miles or hundreds of miles (e.g., long-range communication). A long-range network may include, for example, a cell phone network, a metropolitan area network, a wide area network, a cloud network or any other type of long-range network, including the Internet. A long-range network may be a combination of wired and wireless networks. A mobile vehicle may communicate via a long-range network using any suitable communication protocol.

### 13. Short-Range Communication

The mobile vehicle 130 and the remote equipment 120 may communicate via short-range wireless broadcast and or a short-range wireless link (e.g., 170). A short-range wireless link refers to wireless communication over distances up to a few miles, for example 0.5-9 miles. A short-range network may also be referred to as a local network. Short-range network communication protocols may include, for example, cellular, WiFi (e.g., 802.11a/b/g/n), Bluetooth and ZigBee. The throughput of short-range communication (e.g., bit rate) may be high. The mobile vehicle 130 and the remote equipment 120 may communicate via short-range wireless communication using any suitable communication protocol.

### 14. Afterword

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A method performed by a vehicle while driving along a road, the method comprising:
selecting a remote equipment as a present remote equipment;
determining a geographic location of the present remote equipment;
determining a transmission range of the present remote equipment;
identifying one or more segments of the road that are overlapped by the transmission range of a wireless transmitter of the present remote equipment; and
determining a length of each segment along the road of the one or more segments.

2. The method of claim 1 further comprising storing a description of the one or more segments in a remote equipment data.

3. The method of claim 1 further comprising repeating selecting, determining the geographic location, determining the transmission range, identifying, determining the length and storing for each remote equipment positioned along the road.

4. The method of claim 1 wherein selecting the remote equipment as the present remote equipment comprises selecting a closest remote equipment of one or more remote equipment that lie along the road ahead in a direction of travel as the present remote equipment.

5. The method of claim 1 wherein determining at least one of the geographic location and the transmission range of the present remote equipment comprises accessing a remote equipment data.

6. The method of claim 1 wherein identifying the one or more segments of the road that are overlapped by the transmission range comprises:
overlaying a geometric shape that represents the transmission range over a map data of an area surrounding the geographic location of the present remote equipment; and
identifying the one or more segments of the road that are overlapped by the geometric shape.

7. The method of claim 1 wherein determining the length of each segment comprises:
identifying a first endpoint on the road where the transmission range begins to overlap the road and a second endpoint on the road where the transmission range ceases to overlap the road with a continuous overlap between the first endpoint and the second endpoint; and
calculating a distance along the road between the first endpoint and the second endpoint.

8. The method of claim 7 wherein for each of the one or more segments of the road further storing in a remote equipment data the first endpoint, the second endpoint and the distance.

9. A method performed by a vehicle while traveling along a road, the method comprising:
identifying a next remote equipment in a direction of travel of the vehicle;
determining that a computer of the vehicle holds a data intended for transmission to the next remote equipment;
determining that the vehicle is positioned in the road in range segment (“RIRS”) of the next remote equipment;
determining an amount of time available for transmission;
determining that the amount of time available for transmission is greater than an amount of time needed to transmit the data; and
responsive to determining that the amount of time available for transmission is greater than the amount of time needed to transmit the data, transmitting the data to the next remote equipment.

10. The method of claim 9 wherein the next remote equipment comprises a closest remote equipment of one or more remote equipment that lie ahead along the road in the direction of travel.

11. The method of claim 9 wherein identifying the next remote equipment comprises:
identifying a present geographic location of the vehicle;
identifying one or more remote equipment that lie ahead along the road in the direction of travel that have a wireless transmission range that overlaps the road; and
selecting a closest remote equipment of the one or more remote equipment as the next remote equipment.

12. The method of claim 9 wherein determining that the vehicle is positioned in the RIRS of the next remote equipment comprises:
determining a present geographic location of the vehicle; and
determining that the present geographic location of the vehicle coincides with a segment of the road that is overlapped by a wireless transmission range of the next remote equipment.

13. The method of claim 12 wherein determining the amount of time available for transmission comprises:
determining a distance along the road between the present geographic location of the vehicle and an end of the RIRS;
determining a speed of the vehicle; and
dividing the distance by the speed to determine the amount of time available for transmission.

14. The method of claim 13 wherein a quotient of the distance and the speed of the vehicle is further multiplied by a probability factor to determine an adjusted amount of time available for transmission.

15. The method of claim 9 wherein determining that the amount of time available for transmission is greater than the amount of time needed to transmit the data comprises dividing an amount of the data intended for transmission by a rate of transmission to determine the amount of time needed to transmit the data.

16. A method performed by a vehicle to receive one or more segments of data from a remote equipment, the vehicle traveling along a road in a direction of travel, the method comprising:
receiving a request to transmit data, the vehicle positioned in the road in range segment (“RIRS”) of the remote equipment, the request includes an identifier and an amount of data respectively for each of the one or more segments of data available for transmission;
determining an amount of time available for reception;
identifying which segments of the one or more segments of data may be received in the amount of time available for reception;
transmitting a permit to transmit one or more of the one or more segments of data, the permit includes the identifier for each segment of the one or more segments of data to be transmitted; and
receiving each segment of data identified in the permit.

17. The method of claim 16 wherein determining the amount of time available for reception comprises determining an amount of time the vehicle will be positioned in the RIRS.

18. The method of claim 16 wherein determining the amount of time available for reception comprises determining an amount of time the vehicle will be positioned in all remaining RIRSs of the remote equipment in the direction of travel.

19. The method of claim 16 wherein determining the amount of time available for reception comprises:
determining a present geographic location of the vehicle;
determining a distance along the road between the present geographic location of the vehicle and an end of RIRS in the direction of travel where a wireless transmission range of the remote equipment no longer overlaps the road;
determining a speed of the vehicle; and
dividing the distance along the road by the speed of the vehicle to determine the amount of time available for reception.

20. The method of claim 16 wherein identifying which segments of the one or more segments of data may be received in the amount of time available comprises:
dividing the amount of data for each segment by a rate of transmission of the data to determine a respective amount of time for transmission for each segment of data; and
identifying a combination of segments of data whose respective times for transmission sum to an amount that is less than the amount of time available for reception.
